(19) United States
(12) Patent Application Publication
(10) Pub. No.: US 2026/0237743 A1
(43) Pub. Date: Aug. 13, 2026

(54) NONAQUEOUS ELECTROLYTIC SOLUTION FOR BATTERY, LITHIUM SECONDARY BATTERY PRECURSOR, LITHIUM SECONDARY BATTERY, AND METHOD FOR PRODUCING LITHIUM SECONDARY BATTERY

(71) Applicant: MITSUI CHEMICALS, INC., Chuo-ku, Tokyo (JP)

(72) Inventors: Yuma GOGYO, Chuo-ku, Tokyo (JP); Keita NAGAKAWA, Chuo-ku, Tokyo (JP); Masahiro SUGURO, Chuo-ku, Tokyo (JP); Hidenobu NOGI, Chuo-ku, Tokyo (JP); Masato EGUCHI, Chuo-ku, Tokyo (JP); Hitoshi ONISHI, Chuo-ku, Tokyo (JP); Akihito SHIGEMATSU, Chuo-ku, Tokyo (JP); Yurika OJI, Chuo-ku, Tokyo (JP)

(73) Assignee: MITSUI CHEMICALS, INC., Chuo-ku, Tokyo (JP)

(21) Appl. No.: 19/154,838

(22) PCT Filed: Feb. 9, 2024
(86) PCT No.: PCT/JP2024/004628

§ 371 Date: Aug. 8, 2025

(30) Foreign Application Priority Data
Feb. 9, 2023 (JP) 2023-018744
Mar. 15, 2023 (JP) 2023-040531
Jun. 26, 2023 (JP) 2023-104562

(51) Int. Cl. H01M 10/0568; H01M 4/02; H01M 4/04; H01M 4/58; H01M 10/052; H01M 10/0567

(52) U.S. Cl. CPC H01M 10/0568; H01M 4/0445; H01M 4/5825; H01M 10/052; H01M 10/0567; H01M 2004/028

(57) ABSTRACT

The nonaqueous electrolytic solution for a battery includes a compound (A) and a compound (B), wherein the compound (A) is at least one selected from the group consisting of compounds (1) to (8), the compound (B) is at least one selected from the group consisting of compounds (9) to (11), R¹¹ represents, e.g., Formula (i-1), (i-2), or (i-3), Formula (i-3) represents, e.g., Formula (i-4), * represents a binding position, each of R¹², R¹⁵, R³¹, R⁸¹, Q¹, and Q² represents a divalent group, each of R¹³, R¹⁴, R³², R⁴¹, R⁴², R⁵¹ to R⁵⁴, R⁶¹, R⁶², R⁷¹, R³², R⁹¹, R⁹², R¹⁰¹ to R¹⁰³, and R¹¹¹ to R¹¹³ represents a monovalent group, each M in Formulae (3), (6), and (11) represents an alkali metal, b represents 1 to 3, m represents 1 to 4, n represents 0 to 8, q represents 0 or 1.

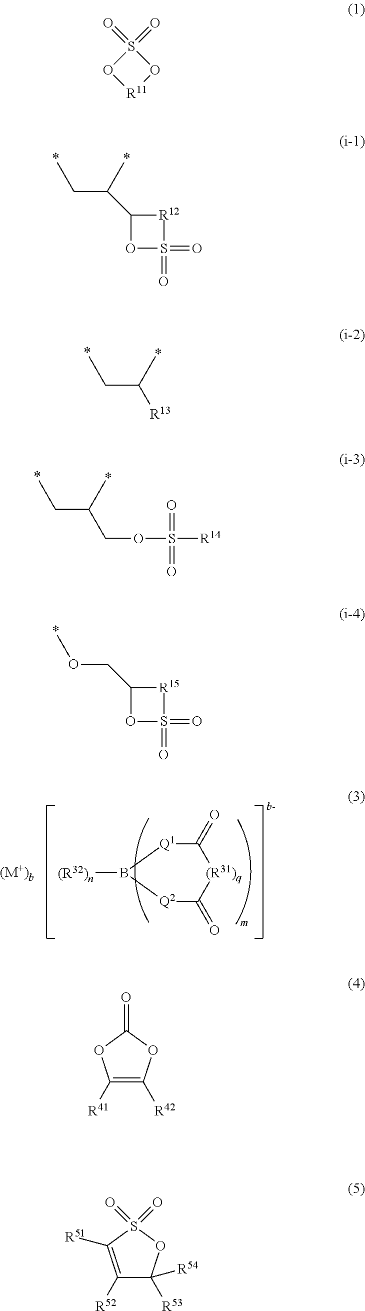

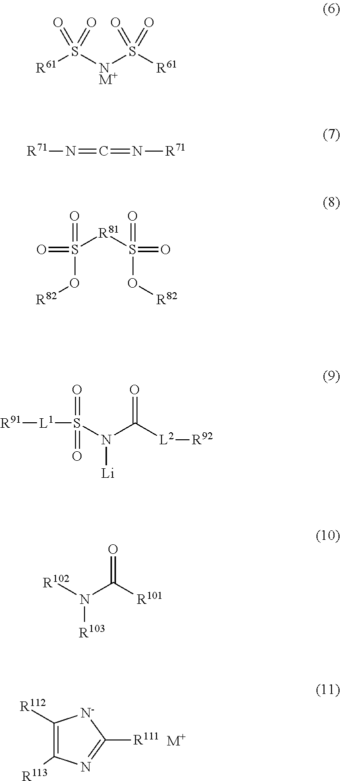

### TECHNICAL FIELD

The present disclosure relates to a nonaqueous electrolytic solution for a battery, a lithium secondary battery precursor, a lithium secondary battery, and a method for producing a lithium secondary battery.

### BACKGROUND ART

In recent years, various studies have been conducted on nonaqueous electrolytic solutions for batteries.

For example, Patent Document 1 discloses a battery that includes a positive electrode active material containing lithium iron phosphate.
Patent Document 1: Japanese Patent (JP) No. 5317390

### SUMMARY

### Technical Problem

In recent years, the evaluation items for lithium ion secondary batteries have become diversified. For example, the resistance value and capacity retention rate after storage in a high-temperature environment, and the resistance value in a region where the state of charge (SOC) is medium or lower (for example, a region with SOC of 50%, the same applies hereinafter) are also important evaluation items that leaves room for improvement.

An object of an aspect according to the present disclosure is to provide a nonaqueous electrolytic solution capable of improving various characteristics of a lithium ion secondary battery, more specifically, improving the capacity retention rate after high-temperature storage, or reducing resistance of a battery in a region where SOC is medium or lower.

An object of another aspect according to the present disclosure is to provide a lithium secondary battery including a nonaqueous electrolytic solution for a battery, in which the capacity retention rate after storage in a high-temperature is improved or the resistance value in a region where SOC is medium or lower is reduced, and to provide a method for producing the lithium secondary battery, and a lithium secondary battery precursor from which the lithium secondary battery can be produced.

### Solution to Problem

Means for solving the above problems include the following aspects.
<1> A nonaqueous electrolytic solution for a battery, the solution including a compound (A) and a compound (B), in which:
the compound (A) is at least one selected from the group consisting of a compound (1) represented by the following Formula (1), a compound (2) that is at least one selected from the group consisting of lithium monofluorophosphate and lithium difluorophosphate, a compound (3) represented by the following Formula (3), a compound (4) represented by the following Formula (4), a compound (5) represented by the following Formula (5), a compound (6) represented by the following Formula (6), a compound (7) represented by the following Formula (7), and a compound (8) represented by the following Formula (8), and
the compound (B) is at least one selected from the group consisting of a compound (9) represented by the following Formula (9), a compound (10) represented by the following Formula (10), and a compound (11) represented by the following Formula (11):

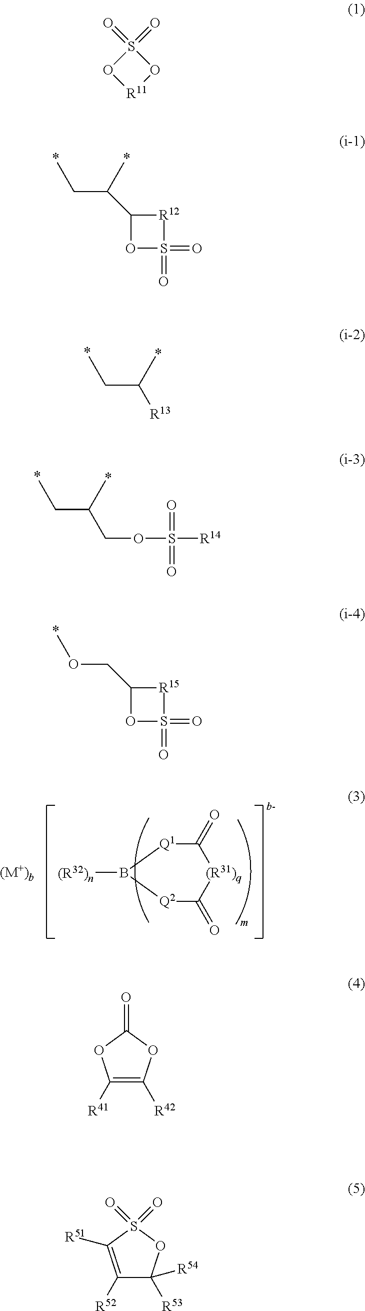

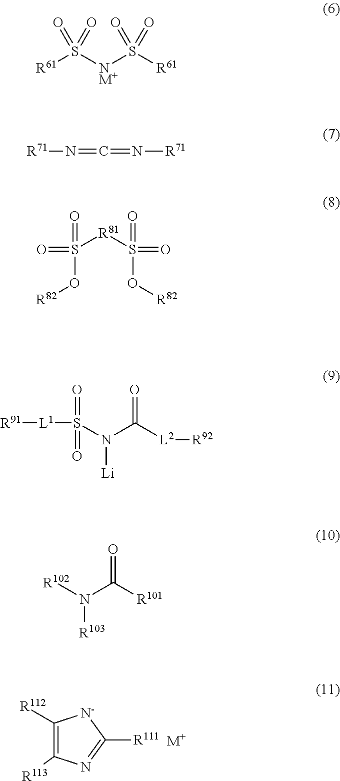

in which, in Formula (1),
R¹¹ represents an alkylene group having 1 to 6 carbon atoms, an alkenylene group having 2 to 6 carbon atoms, a group represented by Formula (i-1), a group represented by Formula (i-2), or a group represented by Formula (i-3),
in Formula (i-1), R¹² represents an oxygen atom, an alkylene group having 1 to 6 carbon atoms, an alkenylene group having 2 to 6 carbon atoms, or an oxymethylene group, and * represents a binding position,
in Formula (i-2), R¹³ represents an alkyl group having 1 to 6 carbon atoms, an alkenyl group having 2 to 6 carbon atoms, or a hydrogen atom, and * represents a binding position,
in Formula (i-3), R¹⁴ represents a halogen atom, an alkyl group having 1 to 6 carbon atoms, a halogenated alkyl group having 1 to 6 carbon atoms, an alkoxy group having 1 to 6 carbon atoms, or a group represented by Formula (i-4), and * represents a binding position, and
in Formula (i-4), R¹⁵ represents an oxygen atom, an alkylene group having 1 to 6 carbon atoms, an alkenylene group having 2 to 6 carbon atoms, or an oxymethylene group, and * represents a binding position;
in Formula (3), M represents an alkali metal, b represents an integer from 1 to 3, m represents an integer from 1 to 4, n represents an integer from 0 to 8, and q represents 0 or 1,
R³¹ represents an alkylene group having 1 to 10 carbon atoms, a halogenated alkylene group having 1 to 10 carbon atoms, an arylene group having 6 to 20 carbon atoms, or a halogenated arylene group having 6 to 20 carbon atoms, these groups may include a substituent or a heteroatom in their structure, and when q is 1 and m is 2 to 4, m instances of R³¹ may be bound together,
R³² represents a halogen atom, an alkyl group having 1 to 10 carbon atoms, a halogenated alkyl group having 1 to 10 carbon atoms, an aryl group having 6 to 20 carbon atoms, or a halogenated aryl group having 6 to 20 carbon atoms, these groups may include a substituent or a heteroatom in their structure, and when n is 2 to 8, n instances of R³² may be linked together to form a ring,
each of Q¹ and Q² independently represents —O— or —CH₂—;
in Formula (4), each of R⁴¹ and R⁴² independently represents a hydrogen atom, a fluorine atom, a hydrocarbon group having 1 to 3 carbon atoms, or a fluorinated hydrocarbon group having 1 to 3 carbon atoms,
in Formula (5), each of R⁵¹ to R⁵⁴ independently represents a hydrogen atom, a fluorine atom, a hydrocarbon group having 1 to 3 carbon atoms, or a fluorinated hydrocarbon group having 1 to 3 carbon atoms, and a double line composed of a solid line and a dotted line represents a single bond or a double bond,
in Formula (6), each R⁶¹ independently represents a fluorine atom or a fluorinated hydrocarbon group having 1 to 6 carbon atoms, and
M represents an alkali metal,
in Formula (7), each R⁷¹ independently represents a hydrocarbon group having 1 to 10 carbon atoms or a trialkylsilyl group having 3 to 18 carbon atoms,
in Formula (8), each R⁸¹ represents an alkylene group having 1 to 10 carbon atoms or a halogenated alkylene group having 1 to 10 carbon atoms and,
each R⁸² independently represents a hydrocarbon group having 1 to 10 carbon atoms or a halogenated hydrocarbon group having 1 to 10 carbon atoms, and, optionally, two R⁸²s may be linked to each other to form a divalent hydrocarbon group having 1 to 10 carbon atoms or a divalent halogenated hydrocarbon group having 1 to 10 carbon atoms,
in Formula (9),
each of R⁹¹ and R⁹² independently represents an alkyl group having 1 to 10 carbon atoms in which at least one hydrogen atom of the alkyl group may be substituted with a halogen atom, an alkenyl group having 2 to 10 carbon atoms in which at least one hydrogen atom of the alkenyl group may be substituted with a halogen atom, an alkynyl group having 2 to 10 carbon atoms in which at least one hydrogen atom of the alkynyl group may be substituted with a halogen atom, an aryl group in which at least one hydrogen atom of the aryl group may be substituted with a halogen atom, an alkoxy group having 1 to 6 carbon atoms, or an alkyl group having 1 to 6 carbon atoms, or a halogen atom, and
each of L¹ and L² independently represents a single bond or —O—,
in Formula (10), each of R¹⁰¹ to R¹⁰³ independently represents a hydrogen atom or a hydrocarbon group having 1 to 10 carbon atoms,
in Formula (11),
R¹¹¹ represents a hydrogen atom, a hydrocarbon group having 1 to 10 carbon atoms, or a fluorinated hydrocarbon group having 1 to 10 carbon atoms, and
each of R¹¹² and R¹¹³ independently represents a hydrogen atom, a cyano group, a hydrocarbon group having 1 to 6 carbon atoms, a hydrocarbon group having 1 to 6 carbon atoms and having a cyano group, or a halogenated hydrocarbon group having 1 to 6 carbon atoms, provided that at least one of R¹¹² or R¹¹³ is a cyano group or a hydrocarbon group having 1 to 6 carbon atoms and having a cyano group, and
M represents an alkali metal.
<2> The nonaqueous electrolytic solution for a battery according to <1>, in which:
the compound (A) is composed of the compound (2) and at least one selected from the group consisting of the compound (3), the compound (4), the compound (4), the compound (5), the compound (6), the compound (7), and the compound (8), and
the compound (B) is composed of a compound (9).
<3> The nonaqueous electrolytic solution for a battery according to <1>, in which:
the compound (A) is composed of the compound (1) and at least one selected from the group consisting of the compound (2), the compound (3), the compound (4), the compound (5), the compound (6), the compound (7), and the compound (8), and
the compound (B) is composed of the compound (9).
<4> The nonaqueous electrolytic solution for a battery according to <1>, in which:
the compound (A) is composed of the compound (1), and
the compound (B) is composed of the compound (9) and at least one selected from the group consisting of the compound (10) and the compound (11).
<5> The nonaqueous electrolytic solution for a battery according to <1>, in which the compound (A) includes the compound (5).
<6> The nonaqueous electrolytic solution for a battery according to <1>, in which the compound (A) includes the compound (7).
<7> The nonaqueous electrolytic solution for a battery according to <1>, in which the compound (A) includes the compound (8).
<8> The nonaqueous electrolytic solution for a battery according to <1>, which is used in a lithium secondary battery including a positive electrode active material including a lithium metal phosphate.
<9> The nonaqueous electrolytic solution for a battery according to <8>, in which:
the compound (A) is composed of at least one selected from the group consisting of the compound (1), the compound (2), the compound (3), and the compound (4), and
the compound (B) is composed of at least one selected from the group consisting of the compound (9) and the compound (10).
<10> A lithium secondary battery precursor, including
a case and
a positive electrode, a negative electrode, a separator, and an electrolytic solution housed in the case, in which:
the positive electrode includes a positive electrode active material including a lithium metal phosphate, and
the electrolytic solution is the nonaqueous electrolytic solution for a battery according to any one of <1> to <9>.
<11> A lithium secondary battery obtained by subjecting the lithium secondary battery precursor according to <10> to charging and discharging.
<12> A method for producing a lithium secondary battery, the method including:
a step of preparing the lithium secondary battery precursor according to <10>; and
a step of subjecting the lithium secondary battery precursor to charging and discharging.

### Advantageous Effects of Invention

According to an aspect of the present disclosure, there is provided a nonaqueous electrolytic solution for a battery capable of improving the capacity retention rate during storage of a battery including a positive electrode active material including a lithium metal phosphate.

According to another aspect of the present disclosure, there is provided a lithium secondary battery having a positive electrode including a positive electrode active material including a lithium metal phosphate and a nonaqueous electrolytic solution for a battery, in which the capacity retention rate during storage is improved, and there is provided a method for producing the lithium secondary battery, and a lithium secondary battery precursor from which the lithium secondary battery can be produced.

### BRIEF DESCRIPTION OF DRAWINGS

FIG. 1 illustrates a schematic cross-sectional view of a laminate-type lithium secondary battery, which is one example of a lithium secondary battery precursor according to the present disclosure.

FIG. 2 illustrates a schematic cross-sectional view of a coin-type lithium secondary battery, which is another example of the lithium secondary battery precursor according to the present disclosure.

### DESCRIPTION OF EMBODIMENTS

In the present specification, any numerical range expressed using “to” refers to a range that includes the values before and after “to” as the minimum and maximum values, respectively.

In the present specification, in a case in which multiple substances corresponding to a component are present in the composition, the amount of the component in the composition means the total amount of these substances present in the composition, unless otherwise specified.

In the present specification, the term “step” encompasses not only an independent step but also any step that can achieve its predetermined purpose even if it cannot be clearly distinguished from another step.

### [Nonaqueous Electrolytic Solution for Battery]

The nonaqueous electrolytic solution for a battery (hereinafter, also simply referred to as “the nonaqueous electrolytic solution”) according to the present disclosure includes a compound (A) and a compound (B).

The compound (A) is at least one selected from the group consisting of a compound (1) represented by Formula (1) described later, a compound (2) that is at least one selected from the group consisting of lithium monofluorophosphate and lithium difluorophosphate, a compound (3) represented by Formula (3) described later, a compound (4) represented by Formula (4) described later, a compound (5) represented by Formula (5) described later, a compound (6) represented by Formula (6) described later, a compound (7) represented by Formula (7) described later, and a compound (8) represented by Formula (8) described later.

The compound (B) is at least one selected from the group consisting of a compound (9) represented by Formula (9) described later, a compound (10) represented by Formula (10) described later, and a compound (11) represented by Formula (11) described later. The nonaqueous electrolytic solution is preferably used in a lithium secondary battery (for example, a lithium secondary battery of the present disclosure described later) including a positive electrode active material including a lithium metal phosphate.

As described above, as a result of studies by the present inventors, it was found that the capacity retention rate of the lithium secondary battery after being stored at a high temperature may be improved, or the resistance in a region where SOC (State of Charge) is medium or lower (for example, a region with SOC of 50%, the same applies hereinafter) may be reduced, respectively. According to the nonaqueous electrolytic solution of the present disclosure, the capacity retention rate after high-temperature storage can be improved, or the resistance of the battery in a region where SOC is medium or lower can be reduced. It is conceivable that the reason for this is that, because the nonaqueous electrolytic solution of the present disclosure includes the compound (A) and the compound (B), either a film having an excellent electrode protection properties or a film having low resistance in a region where SOC is medium or lower is formed on the surface of the electrode.

### <Compound (A)>

The nonaqueous electrolytic solution of the present disclosure includes a compound (A).

The compound (A) is at least one selected from the group consisting of a compound (1) represented by Formula (1) described later, a compound (2) that is at least one selected from the group consisting of lithium monofluorophosphate and lithium difluorophosphate, a compound (3) represented by Formula (3) described later, a compound (4) represented by Formula (4) described later, a compound (5) represented by Formula (5) described later, a compound (6) represented by Formula (6) described later, a compound (7) represented by Formula (7) described later, and a compound (8) represented by Formula (8) described later.

The content of the compound (A) (total content when two or more types of compound are present) is preferably from 0.01% by mass to 5.0% by mass, more preferably from 0.05% by mass to 3.0% by mass, still more preferably from 0.10% by mass to 2.5% by mass, and particularly preferably from 0.10% by mass to 2.0% by mass, with respect to the total amount of the nonaqueous electrolytic solution.

In a case in which a nonaqueous electrolytic solution collected by actually disassembling a lithium secondary battery is analyzed, the amount of the compound (A) sometimes decreases as compared with the amount added to the nonaqueous electrolytic solution. Even in such case, as long as the compound (A) is detected even in a small amount in the nonaqueous electrolytic solution taken out from the lithium secondary battery, the electrolytic solution of the lithium secondary battery falls within the range of the nonaqueous electrolytic solution of the present disclosure.

The same applies to the compound (B) described later.

In the nonaqueous electrolytic solution of the present disclosure, the ratio of the mass of the compound (A) to the mass of the compound (B) (hereinafter, also referred to as “mass ratio [compound (A)/compound (B)]”) is preferably from 0.10 to 10, more preferably from 0.10 to 5.0, still more preferably from 0.10 to 2.0, further preferably from 0.10 to 1.5, particularly preferably 0.10 or more and less than 1.0, and most preferably from 0.10 to 0.90.

Hereinafter, the compounds (1) to (8), which are examples of the compound (A), will be described.

### (Compound (1) Represented by Formula (1))

In the nonaqueous electrolytic solution of the present disclosure, a compound (1), which is an example of the compound (A), is at least one selected from the group consisting of compounds represented by the following Formula (1).

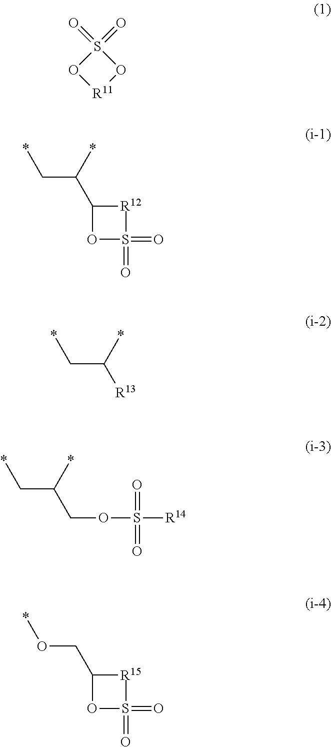

In Formula (1),
R¹¹ represents an alkylene group having 1 to 6 carbon atoms, an alkenylene group having 2 to 6 carbon atoms, a group represented by Formula (i-1), a group represented by Formula (i-2), or a group represented by Formula (i-3),
* represents a binding position,
in Formula (i-1), R¹² represents an oxygen atom, an alkylene group having 1 to 6 carbon atoms, an alkenylene group having 2 to 6 carbon atoms, or an oxymethylene group, and * represents a binding position,
in Formula (i-2), R¹³ represents an alkyl group having 1 to 6 carbon atoms, an alkenyl group having 2 to 6 carbon atoms, or a hydrogen atom, and * represents a binding position,
in Formula (i-3), R¹⁴ represents a halogen atom, an alkyl group having 1 to 6 carbon atoms, a halogenated alkyl group having 1 to 6 carbon atoms, an alkoxy group having 1 to 6 carbon atoms, or a group represented by Formula (i-4), and * represents a binding position,
in Formula (i-4), R¹⁵ represents an oxygen atom, an alkylene group having 1 to 6 carbon atoms, an alkenylene group having 2 to 6 carbon atoms, or an oxymethylene group, and * represents a binding position.

In Formula (1), R¹¹ is preferably a group represented by Formula (i-1) or a group represented by Formula (i-2).

In Formula (i-1), R¹² is preferably an alkylene group having 1 to 3 carbon atoms, an alkenylene group having 1 to 3 carbon atoms, or an oxymethylene group, and more preferably an oxymethylene group.

In Formula (i-2), R¹³ is preferably an alkyl group having 1 to 3 carbon atoms or an alkenyl group having 2 to 3 carbon atoms, and more preferably a propyl group.

Examples of the compound (1) include the following compound (1)-1, the following compound (1)-2, and the following compound (1)-3, and the following compound (1)-1 is particularly preferable.

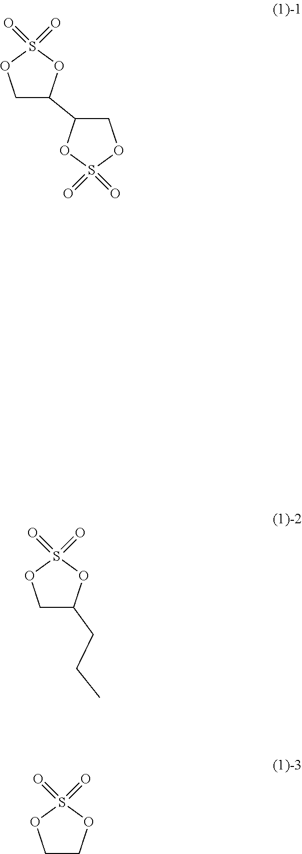

In a case in which the compound (A) includes a compound (1), the content of the compound (1) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

The compound (A) preferably includes the compound (1).

Specifically, the compound (A) is preferably composed of the compound (1) alone, or the compound (1) and at least one selected from the group consisting of the compound (2), the compound (3), the compound (4), and the compound (5).

The compound (A) is more preferably composed of the compound (1) and at least one selected from the group consisting of the compound (2), the compound (3), the compound (4), and the compound (5).

The ratio of the compound (1) in the compound (A) is preferably from 50% by mass to 100% by mass, more preferably from 60% by mass to 100% by mass, and still more preferably from 70% by mass to 90% by mass.

### (Compound (2) Represented by Formula (2))

In the nonaqueous electrolytic solution of the present disclosure, the compound (2), which is an example of the compound (A), is at least one selected from the group consisting of lithium monofluorophosphate and lithium difluorophosphate.

“Compound (2)-1” in Examples described later is lithium difluorophosphate.

In a case in which the compound (A) includes a compound (2), the content of the compound (2) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

### (Compound (3) Represented by Formula (3))

The compound (3), which is an example of the compound (A), is at least one selected from the group consisting of compounds represented by the following Formula (3).

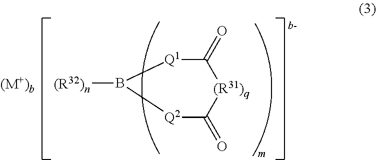

In Formula (3),
M represents an alkali metal,
b represents an integer from 1 to 3,
m represents an integer from 1 to 4,
n represents an integer from 0 to 8,
q represents 0 or 1,
R³¹ represents an alkylene group having 1 to 10 carbon atoms, a halogenated alkylene group having 1 to 10 carbon atoms, an arylene group having 6 to 20 carbon atoms, or a halogenated arylene group having 6 to 20 carbon atoms, these groups may include a substituent or a heteroatom in their structure, and when q is 1 and m is 2 to 4, m instances of R³¹ may be bound together,
R³² represents a halogen atom, an alkyl group having 1 to 10 carbon atoms, a halogenated alkyl group having 1 to 10 carbon atoms, an aryl group having 6 to 20 carbon atoms, or a halogenated aryl group having 6 to 20 carbon atoms, these groups may include a substituent or a heteroatom in their structure, and when n is 2 to 8, n instances of R³² may be linked together to form a ring,
each of Q¹ and Q² independently represents —O— or —CH₂—.
M is an alkali metal.

Examples of the alkali metal include lithium, sodium, and potassium. Among these, M is preferably lithium.
b represents the valence of the anion and the number of cations. b is an integer from 1 to 3 and preferably 1. In a case in which b is 3 or less, the salt of the anion compound is easily dissolved in the mixed organic solvent.

Each of m and n is a value related to the number of ligands. Each of m and n is determined depending on the type of M. m is an integer from 1 to 4. n is an integer from 0 to 8.
q is 0 or 1. In a case in which q is 0, the chelate ring is a five-membered ring, and when q is 1, the chelate ring is a six-membered ring.
R³¹ represents an alkylene group having 1 to 10 carbon atoms, a halogenated alkylene group having 1 to 10 carbon atoms, an arylene group having 6 to 20 carbon atoms, or a halogenated arylene group having 6 to 20 carbon atoms. These alkylene groups, halogenated alkylene groups, arylene groups, or halogenated arylene groups may include a substituent or a heteroatom in their structures. Specifically, a substituent may be present in place of the hydrogen atom of these groups. Examples of the substituent include a halogen atom, an acyclic or cyclic alkyl group, an aryl group, an alkenyl group, an alkoxy group, an aryloxy group, a sulfonyl group, an amino group, a cyano group, a carbonyl group, an acyl group, an amide group, and a hydroxyl group. The substituent may have a structure in which a nitrogen atom, a sulfur atom, or an oxygen atom is introduced in place of a carbon atom of these substituents. In a case in which q is 1 and m is 2 to 4, m instances of R³¹ may be bound together. Examples thereof include a ligand such as ethylenediaminetetraacetic acid.
R³² represents a halogen atom, an alkyl group having 1 to 10 carbon atoms, a halogenated alkyl group having 1 to 10 carbon atoms, an aryl group having 6 to 20 carbon atoms, or a halogenated aryl group having 6 to 20 carbon atoms. These alkyl groups, halogenated alkyl groups, aryl groups or halogenated aryl groups may include a substituent or a heteroatom in their structures, similarly to R³¹. When n is 2 to 8, n instances of R³² may be linked together to form a ring. R³² is preferably an electron-attracting group, and particularly preferably a fluorine atom.
each of Q¹ and Q² independently represents —O— or —CH₂—. That is, the ligand is bonded to B (boron atom) via Q¹ and Q².

Examples of the compound (3) include the following compound (3)-1 and the following compound (3)-2, and the following compound (3)-1 is particularly preferable.

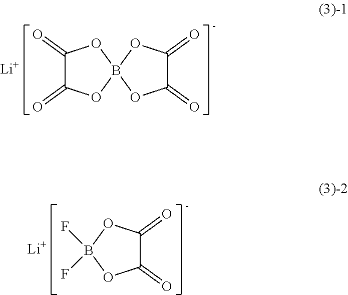

In a case in which the compound (A) includes the compound (3), the content of the compound (3) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

### (Compound (4) Represented by Formula (4))

The compound (4), which is an example of the compound (A), is at least one selected from the group consisting of compounds represented by the following Formula (4).

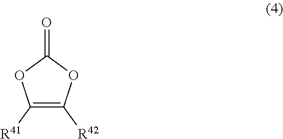

In Formula (4), each of R⁴¹ and R⁴² independently represents a hydrogen atom, a fluorine atom, a hydrocarbon group having 1 to 3 carbon atoms, or a fluorinated hydrocarbon group having 1 to 3 carbon atoms.

In Formula (4), the hydrocarbon group having 1 to 6 carbon atoms, represented by each of R⁴¹ and R⁴², may be a linear hydrocarbon group, or may be a hydrocarbon group having a branched structure and/or a ring structure.

The hydrocarbon group having 1 to 6 carbon atoms, represented by each of R⁴¹ and R⁴², is preferably an alkyl group or an aryl group, and more preferably an alkyl group.

The number of carbon atoms in the hydrocarbon group having 1 to 6 carbon atoms, represented by each of R⁴¹ and R⁴², is preferably from 1 to 3, more preferably 1 or 2, and particularly preferably 1.

In Formula (4), the fluorinated hydrocarbon group having 1 to 6 carbon atoms, represented by R⁵¹ or R², may be a linear fluorinated hydrocarbon group, or may be a fluorinated hydrocarbon group having a branched structure and/or a ring structure.

The number of carbon atoms in the fluorinated hydrocarbon group having 1 to 6 carbon atoms, represented by R⁵¹ or R⁵², is preferably from 1 to 3, more preferably 1 or 2, and particularly preferably 1.

Examples of the compound (4) include a group of compounds disclosed in paragraph [0062] of International Publication (WO) No. 2020/121850.

As the compound (4), the following compound (4)-1 is particularly preferable.

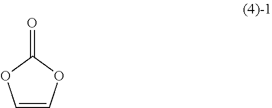

In a case in which the compound (A) includes the compound (4), the content of the compound (4) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

### (Compound (5) Represented by Formula (5))

The compound (5), which is an example of the compound (A), is at least one selected from the group consisting of compounds represented by the following Formula (5).

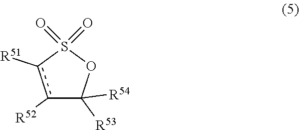

In Formula (5), each of R⁵¹ to R⁵ independently represents a hydrogen atom, a fluorine atom, a hydrocarbon group having 1 to 3 carbon atoms, or a fluorinated hydrocarbon group having 1 to 3 carbon atoms, and a double line composed of a solid line and a dotted line represents a single bond or a double bond.

In Formula (5), the hydrocarbon group having 1 to 3 carbon atoms, represented by each of R⁵¹ to R⁵⁴, may be a linear hydrocarbon group, or may be a hydrocarbon group having a branched structure.

As the hydrocarbon group having 1 to 3 carbon atoms represented by each of R⁵¹ to R⁵, an alkyl group having 1 to 3 carbon atoms is preferable, an alkyl group having 1 or 2 carbon atoms is more preferable, and an alkyl group having 1 carbon atom is still more preferable.

In Formula (5), the fluorinated hydrocarbon group having 1 to 3 carbon atoms, represented by each of R⁵¹ to R⁵⁴, may be a linear fluorinated hydrocarbon group, or may be a fluorinated hydrocarbon group having a branched structure.

As the fluorinated hydrocarbon group having 1 to 3 carbon atoms, represented by each of R⁵¹ to R⁵⁴, a fluoroalkyl group having 1 to 3 carbon atoms is preferable, a fluoroalkyl group having 1 or 2 carbon atoms is more preferable, and a fluoroalkyl group having 1 carbon atom is still more preferable.

Examples of the compound (5) include a group of compounds disclosed in paragraph [0085] of International Publication (WO) No. 2020/121850.

As the compound (5), the following compound (5)-1 and the following compound (5)-2 are particularly preferable.

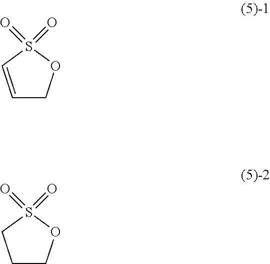 [SMILES: O=S1(=O)C=CCO1 ; O=S1(=O)CCCO1]

In a case in which the compound (A) includes the compound (5), the content of the compound (5) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

### (Compound (6) Represented by Formula (6))

The compound (6), which is an example of the compound (A), is at least one selected from the group consisting of compounds represented by the following Formula (6).

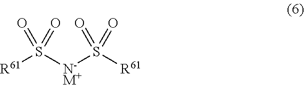

In Formula (6), each R⁶¹ independently represents a fluorine atom or a fluorinated hydrocarbon group having 1 to 6 carbon atoms, and M represents an alkali metal.

In Formula (6), the fluorinated hydrocarbon group having 1 to 3 carbon atoms represented by R⁶¹ may be a linear fluorinated hydrocarbon group, or may be a fluorinated hydrocarbon group having a branched structure.

Examples of R⁶¹ that are more preferable include a fluorine atom (fluoro group, —F), a trifluoromethyl group (—CF₃), and a pentafluoroethyl group (—CF₂CF₃).

M is an alkali metal, and examples of the alkali metal include lithium, sodium, and potassium. Among them, M is preferably lithium.

As the compound (6), the following compound (6)-1 and the following compound (6)-2 are particularly preferable.

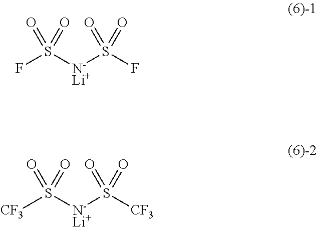

In a case in which the compound (A) includes the compound (6), the content of the compound (6) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

### (Compound (7) Represented by Formula (7))

The compound (7), which is an example of the compound (A), is at least one selected from the group consisting of compounds represented by the following Formula (7).

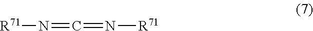

In Formula (7), each R⁷¹ independently represents a hydrocarbon group having 1 to 10 carbon atoms or a trialkylsilyl group having 3 to 18 carbon atoms.

In Formula (7), the hydrocarbon group having 1 to 10 carbon atoms represented by R⁷¹ may be a linear hydrocarbon group, a hydrocarbon group having a branched structure, or a hydrocarbon group having a ring structure.

The hydrocarbon group having 1 to 10 carbon atoms represented by R⁷¹ is preferably an alkyl group having 1 to 8 carbon atoms.

In Formula (7), the trialkylsilyl group having 3 to 18 carbon atoms represented by R⁷¹ is preferably a trimethylsilyl group (—Si(CH₃)₃), a triethylsilyl group (—Si(C₂H₅)₃), a tri t-butylsilyl group (—Si(tC₄H₉)₃), or a triphenylsilyl group (—Si(C₆H₅)₃).

As the compound (7), the following compound (7)-1, the following compound (7)-2, and the following compound (7)-3 are particularly preferable.

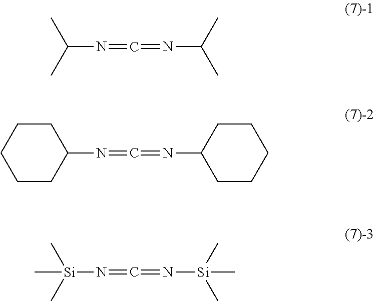

In a case in which the compound (A) includes the compound (7), the content of the compound (7) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

### (Compound (8) Represented by Formula (8))

The compound (8), which is an example of the compound (A), is at least one selected from the group consisting of compounds represented by the following Formula (8).

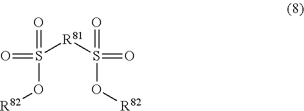

In Formula (8), R⁸¹ represents an alkylene group having 1 to 10 carbon atoms or a halogenated alkylene group having 1 to 10 carbon atoms, and each R⁸² independently represents a hydrocarbon group having 1 to 10 carbon atoms or a halogenated hydrocarbon group having 1 to 10 carbon atoms, and, optionally, two R⁸²s may be linked together to form a divalent hydrocarbon group having 1 to 10 carbon atoms or a divalent halogenated hydrocarbon group having 1 to 10 carbon atoms.

In Formula (8), the alkylene group having 1 to 10 carbon atoms represented by R⁸¹ may be a linear alkylene group, or may be an alkylene group having a branched structure.

As the alkylene group having 1 to 10 carbon atoms represented by R⁸¹, an alkylene group having 1 to 3 carbon atoms is preferable, an alkylene group having 1 or 2 carbon atoms is more preferable, and a methylene group is particularly preferable.

In Formula (8), the halogenated alkylene group having 1 to 10 carbon atoms represented by R⁸¹ may be a linear halogenated alkylene group, or may be a halogenated alkylene group having a branched structure.

As the halogenated alkylene group having 1 to 10 carbon atoms represented by R⁸¹, a halogenated alkylene group having 1 to 3 carbon atoms is preferable, a halogenated alkylene group having 1 or 2 carbon atoms is more preferable, and a difluoromethylene group is particularly preferable.

In Formula (8), the hydrocarbon group having 1 to 10 carbon atoms represented by R⁸² may be a linear hydrocarbon group, or may be a hydrocarbon group having a branched structure.

As the hydrocarbon group having 1 to 10 carbon atoms represented by R⁸², a hydrocarbon group having 1 to 3 carbon atoms is preferable, a hydrocarbon group having 1 or 2 carbon atoms is more preferable, and a methyl group is particularly preferable.

In Formula (8), the halogenated hydrocarbon group having 1 to 10 carbon atoms represented by R⁸² may be a linear halogenated hydrocarbon group, or may be a halogenated hydrocarbon group having a branched structure.

As the halogenated hydrocarbon group having 1 to 10 carbon atoms represented by R⁸², a halogenated hydrocarbon group having 1 to 3 carbon atoms is preferable, a halogenated hydrocarbon group having 1 or 2 carbon atoms is more preferable, and a trifluoromethyl group is particularly preferable.

In Formula (8), in a case in which two R⁸²s are linked together to form a divalent hydrocarbon group having 1 to 10 carbon atoms or a divalent halogenated hydrocarbon group having 1 to 10 carbon atoms, the group sandwiched between the two oxa groups (—O—), i.e., the divalent hydrocarbon group having 1 to 10 carbon atoms or the divalent halogenated hydrocarbon group having 1 to 10 carbon atoms, may be a linear hydrocarbon or halogenated hydrocarbon group, or may be a hydrocarbon or halogenated hydrocarbon group having a branched structure.

In Formula (8), when two R⁸²s are linked together to form a divalent hydrocarbon group having 1 to 10 carbon atoms or a divalent halogenated hydrocarbon group having 1 to 10 carbon atoms, the group sandwiched between the two oxa groups (—O—), i.e., the divalent hydrocarbon group having 1 to 10 carbon atoms or the divalent halogenated hydrocarbon group having 1 to 10 carbon atoms, is preferably a methylene group, a difluoromethylene group, an ethylene group, or a tetrafluoroethylene group.

Examples of the compound (8) include the following compounds (8)-1 to (8)-13. The following compound (8)-1 is particularly preferable.

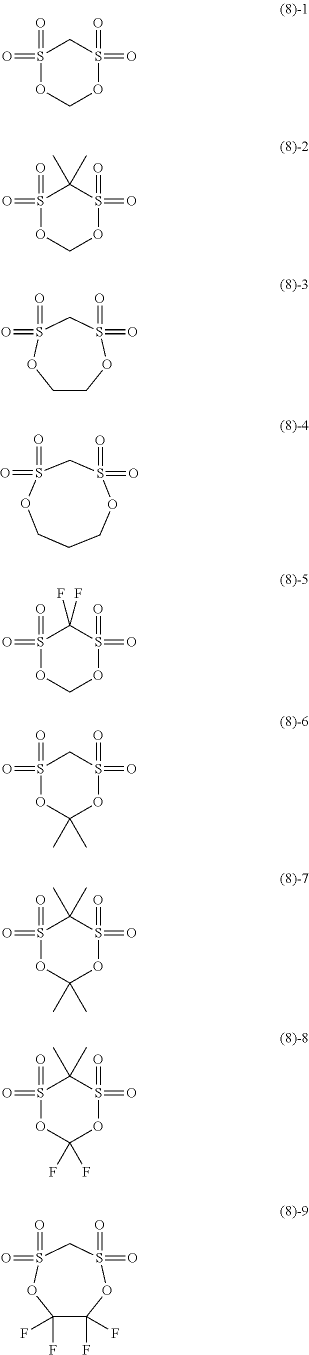

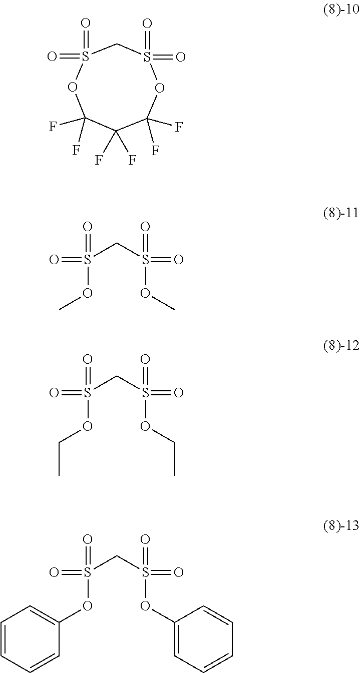 [SMILES: O=S1(=O)CS(=O)(=O)OC(F)(F)C(F)(F)C(F)(F)O1 ; COS(=O)(=O)CS(=O)(=O)OC ; CCOS(=O)(=O)CS(=O)(=O)OCC ; O=S(=O)(CS(=O)(=O)Oc1ccccc1)Oc1ccccc1]

In a case in which the compound (A) includes the compound (8), the content of the compound (8) with respect to the total amount of the nonaqueous electrolytic solution is preferably from 0.01% by mass to 5.0% by mass, more preferably from 0.05% by mass to 3.0% by mass, still more preferably from 0.10% by mass to 1.5% by mass, and particularly preferably from 0.10% by mass to 1.0% by mass, with respect to the total amount of the nonaqueous electrolytic solution.

### <Compound (B)>

The nonaqueous electrolytic solution of the present disclosure includes the compound (B).

The compound (B) is at least one selected from the group consisting of a compound (9) represented by Formula (9) described later, a compound (10) represented by Formula (10) described later, and a compound (11) represented by Formula (11) described later.

The content of the compound (B) (total content when two or more types of compound are present) is preferably from 0.01% by mass to 5.0% by mass, more preferably from 0.05% by mass to 3.0% by mass, still more preferably from 0.10% by mass to 1.5% by mass, and particularly preferably from 0.20% by mass to 1.5% by mass with respect to the total amount of the nonaqueous electrolytic solution.

The preferred range of the mass ratio [compound (A)/compound (B)] is as described above.

Hereinafter, compounds (9) to (11) provided as options of the compound (B) will be described.

### (Compound (9) Represented by Formula (9))

The compound (9), which is an example of the compound (B), is at least one selected from the group consisting of compounds represented by the following Formula (9).

The compound (9) falls under a lithium (N-carbonyl)sulfonamide compound.

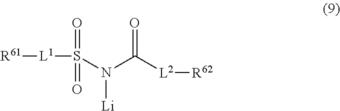

In Formula (9),
each of R⁹¹ and R⁹² independently represents an alkyl group having 1 to 10 carbon atoms in which at least one hydrogen atom of the alkyl group may be substituted with a halogen atom, an alkenyl group having 2 to 10 carbon atoms in which at least one hydrogen atom of the alkenyl group may be substituted with a halogen atom, an alkynyl group having 2 to 10 carbon atoms in which at least one hydrogen atom of the alkynyl group may be substituted with a halogen atom, an aryl group in which at least one hydrogen atom of the aryl group may be substituted with a halogen atom, an alkoxy group having 1 to 6 carbon atoms, or an alkyl group having 1 to 6 carbon atoms, or a halogen atom, and each of L¹ and L² independently represents a single bond or —O—.

In Formula (9), the “alkyl group having 1 to 10 carbon atoms” represented by each of R⁹¹ and R⁹² is a linear or branched alkyl group having 1 to 10 carbon atoms. Examples of the “alkyl group having 1 to 10 carbon atoms” include a methyl group, an ethyl group, a propyl group, an isopropyl group, a butyl group, an isobutyl group, a sec-butyl group, a tert-butyl group, a pentyl group, a 2-methylbutyl group, a 1-methylpentyl group, a neopentyl group, a 1-ethylpropyl group, a hexyl group, a 3,3-dimethylbutyl group, a heptyl group, an octyl group, a nonyl group, and a decyl group. Among these, the “alkyl group having 1 to 10 carbon atoms” is preferably an alkyl group having 1 to 6 carbon atoms, and more preferably an alkyl group having 1 to 3 carbon atoms.

In the “alkyl group having 1 to 10 carbon atoms”, at least one hydrogen atom may be substituted with a halogen atom. The halogen atom is preferably a fluorine atom, a chlorine atom, a bromine atom, or an iodine atom, more preferably a fluorine atom, a chlorine atom, or a bromine atom, still more preferably a fluorine atom or a chlorine atom, and particularly preferably a fluorine atom.

In the “alkyl group having 1 to 10 carbon atoms”, the number of hydrogen atoms which may be substituted with a halogen atom is not particularly limited, and is appropriately selected according to the number of carbon atoms in the alkyl group, and is preferably from 1 to 7.

In Formula (9), the “alkenyl group having 2 to 10 carbon atoms” represented by each of R⁹¹ and R⁹² is a linear or branched alkenyl group having 2 to 10 carbon atoms. Examples of the “alkenyl group having 2 to 10 carbon atoms” include a vinyl group, a 2-propenyl group, a 2-butenyl group, a 3-butenyl group, a 2-pentenyl group, a 3-pentenyl group, a 4-pentenyl group, and a 5-hexenyl group. Among these, the “alkenyl group having 2 to 10 carbon atoms” is preferably an alkenyl group having 2 to 6 carbon atoms, and more preferably an alkenyl group having 2 to 3 carbon atoms.

In the “alkenyl group having 2 to 10 carbon atoms”, at least one hydrogen atom may be substituted with a halogen atom. The halogen atom is preferably a fluorine atom, a chlorine atom, a bromine atom, or an iodine atom, more preferably a fluorine atom, a chlorine atom, or a bromine atom, still more preferably a fluorine atom or a chlorine atom, and particularly preferably a fluorine atom.

In the “alkenyl group having 2 to 10 carbon atoms”, the number of hydrogen atoms which may be substituted with a halogen atom is not particularly limited, and is appropriately selected according to the number of carbon atoms in the alkenyl group, and is preferably from 1 to 7.

In Formula (9), the “alkynyl group having 2 to 10 carbon atoms” represented by each of R⁹¹ and R⁹² is a linear or branched alkynyl group having 2 to 10 carbon atoms. Examples of the “alkynyl group having 2 to 10 carbon atoms” include an ethynyl group, a propargyl group (2-propynyl group), a 2-butynyl group, a 3-butynyl group, a 2-pentynyl group, a 3-pentynyl group, a 4-pentynyl group, and a 5-hexynyl group. Among these, the “alkynyl group having 2 to 10 carbon atoms” is preferably an alkynyl group having 2 to 6 carbon atoms, and more preferably an alkynyl group having 2 to 3 carbon atoms.

In the “alkynyl group having 2 to 10 carbon atoms”, at least one hydrogen atom may be substituted with a halogen atom. The halogen atom is preferably a fluorine atom, a chlorine atom, a bromine atom, or an iodine atom, more preferably a fluorine atom, a chlorine atom, or a bromine atom, still more preferably a fluorine atom or a chlorine atom, and particularly preferably a fluorine atom.

In the “alkynyl group having 2 to 10 carbon atoms”, the number of hydrogen atoms which may be substituted with a halogen atom is not particularly limited, and is appropriately selected according to the number of carbon atoms in the alkynyl group, and is preferably from 1 to 7.

In Formula (9), examples of the “aryl group” represented by each of R⁹¹ and R⁹² include a phenyl group and a naphthyl group, and a phenyl group is preferable.

In Formula (9), at least one hydrogen atom of the “aryl group” represented by each of R⁹¹ and R⁹² may be substituted with a halogen atom, an alkoxy group having 1 to 6 carbon atoms, or an alkyl group having 1 to 6 carbon atoms.

The halogen atom is preferably a fluorine atom, a chlorine atom, a bromine atom, or an iodine atom, more preferably a fluorine atom, a chlorine atom, or a bromine atom, still more preferably a fluorine atom or a chlorine atom, and particularly preferably a fluorine atom. In the “aryl group”, the number of hydrogen atoms substituted with a halogen atom is not particularly limited, and is preferably from 1 to 5.

In the alkoxy group having 1 to 6 carbon atoms, the alkyl group may be linear, branched, or cyclic. Examples of the alkoxy group having 1 to 6 carbon atoms include a methoxy group, an ethoxy group, an n-propoxy group, an isopropoxy group, an n-butoxy group, a t-butoxy group, and a pentyloxy group. Among these, the alkoxy group having 1 to 6 carbon atoms is preferably an alkoxy group having 1 to 3 carbon atoms, and more preferably a methoxy group and an ethoxy group. In the “aryl group”, the number of hydrogen atoms which may be substituted with an alkoxy group having 1 to 6 carbon atoms is not particularly limited, and is preferably from 1 to 3.

The alkyl group having 1 to 6 carbon atoms may be linear, branched, or cyclic. Examples of the alkyl group having 1 to 6 carbon atoms include a methyl group, an ethyl group, an n-propyl group, an i-propyl group, an n-butyl group, an i-butyl group, a t-butyl group, an n-pentyl group, an n-hexyl group, and a cyclohexyl group. Among these, the alkyl group having 1 to 6 carbon atoms is preferably an alkyl group having 1 to 3 carbon atoms, and more preferably a methyl group and an ethyl group. In the “aryl group”, the number of hydrogen atoms which may be substituted with an alkyl group having 1 to 6 carbon atoms is not particularly limited, and is preferably from 1 to 3.

In Formula (9), the “halogen atom” represented by each of R⁹¹ and R⁹² is preferably a fluorine atom, a chlorine atom, a bromine atom, or an iodine atom, more preferably a fluorine atom, a chlorine atom, or a bromine atom, still more preferably a fluorine atom or a chlorine atom, and particularly preferably a fluorine atom.

In Formula (9), each of L¹ and L² independently represents a single bond or —O—.

In Formula (9), the combination of L¹ and L² is
preferably a combination in which L¹ is —O— and L² is a single bond or —O—, or a combination in which L² is —O— and L¹ is a single bond or —O—,
more preferably a combination in which L² is —O— and L¹ is a single bond or —O—, and
particularly preferably a combination in which L² is —O— and L¹ is a single bond.

In Formula (9), the combination of R⁹² and L² is
preferably a combination in which R⁹² is an alkyl group having 1 to 3 carbon atoms in which at least one hydrogen atom of the alkyl group may be substituted with a halogen atom, and L² is —O—.

In Formula (9), the combination of R⁹¹ and L¹ is
preferably a combination in which R⁹¹ is a halogen atom and L¹ is a single bond, and
more preferably a combination in which R⁹¹ is a fluorine atom and L¹ is a single bond.

Examples of the compound (9) include a group of compounds disclosed in paragraphs [0206] to [0418] of International Publication (WO) No. 2022/196230.

As the compound (9), the following compound (9)-1 is particularly preferable. A method for synthesizing compound (9)-1 can be found in paragraphs [0389] to [0418] of International Publication (WO) No. 2022/196230 (description of the item “lithium fluorosulfonylmethoxycarbonylamide [synthetic compound (I-42)]” in Synthesis Example 42).

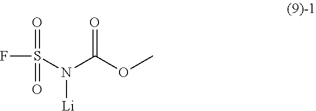

In a case in which the compound (B) includes the compound (9), the content of the compound (9) is preferably from 0.01% by mass to 5.0% by mass, more preferably from 0.05% by mass to 3.0% by mass, still more preferably from 0.10% by mass to 1.5% by mass, and particularly preferably from 0.20% by mass to 1.5% by mass, with respect to the total amount of the nonaqueous electrolytic solution.

It is preferable that the compound (B) includes the compound (9).

Specifically, it is preferable that the compound (B) is composed of the compound (9) alone, or the compound (9) and at least one selected from the group consisting of the compound (10) and the compound (11).

It is more preferable that the compound (A) is composed of the compound (9) and at least one selected from the group consisting of the compound (10) and the compound (11).

The content ratio of the compound (9) in the compound (B) is preferably from 10% by mass to 100% by mass, more preferably from 20% by mass to 100% by mass, still more preferably from 30% by mass to 100% by mass, and particularly preferably from 40% by mass to 90% by mass.

### (Compound (10) Represented by Formula (10))

The compound (10), which is an example of the compound (B), is at least one selected from the group consisting of compounds represented by the following Formula (10).

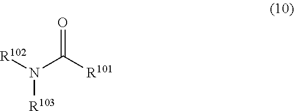

In Formula (10), each of R¹⁰¹ to R¹⁰³ independently represents a hydrogen atom or a hydrocarbon group having 1 to 10 carbon atoms.

The hydrocarbon group having 1 to 10 carbon atoms, represented by R¹⁰¹ to R¹⁰³, may be a linear hydrocarbon group, or may be a hydrocarbon group having a branched structure.

The hydrocarbon group having 1 to 10 carbon atoms, represented by each of R¹⁰¹ to R¹⁰³, is preferably an alkyl group having 1 to 10 carbon atoms, more preferably an alkyl group having 1 to 6 carbon atoms, still more preferably an alkyl group having 1 to 3 carbon atoms, particularly preferably an alkyl group having 1 or 2 carbon atoms, and most preferably an alkyl group having 1 carbon atom (i.e., a methyl group).

It is preferable that each of R¹⁰¹ to R¹⁰³ is independently a hydrocarbon group having 1 to 10 carbon atoms in which an alkyl group having 1 to 10 carbon atoms, more preferable that each of R¹⁰¹ to R¹⁰³ is independently an alkyl group having 1 to 6 carbon atoms, still more preferable that each of R¹⁰¹ to R¹⁰³ is independently an alkyl group having 1 to 3 carbon atoms, particularly preferable that each of R¹⁰¹ to R¹⁰³ is independently an alkyl group having 1 or 2 carbon atoms, and most preferable that each of R¹⁰¹ to R¹⁰³ is independently an alkyl group having 1 carbon atom (i.e., a methyl group).

As the compound (10), the following compound (10)-1 is particularly preferable.

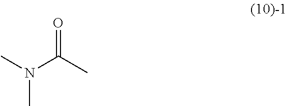

In a case in which the compound (B) includes a compound (10), the content of the compound (10) is preferably from 0.01% by mass to 5.0% by mass, more preferably from 0.05% by mass to 3.0% by mass, still more preferably from 0.10% by mass to 1.5% by mass, and particularly preferably from 0.20% by mass to 1.5% by mass, with respect to the total amount of the nonaqueous electrolytic solution.

### (Compound (11) Represented by Formula (11))

The compound (11), which is an example of the compound (B), is at least one selected from the group consisting of compounds represented by the following Formula (11).

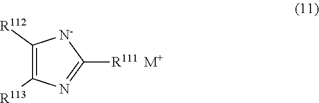

In Formula (11),
R¹¹¹ represents a hydrogen atom, a hydrocarbon group having 1 to 10 carbon atoms, or a fluorinated hydrocarbon group having 1 to 10 carbon atoms, and
each of R¹¹² and R¹¹³ independently represents a hydrogen atom, a cyano group, a hydrocarbon group having 1 to 6 carbon atoms, a hydrocarbon group having 1 to 6 carbon atoms and having a cyano group, or a halogenated hydrocarbon group having 1 to 6 carbon atoms, provided that at least one of R¹¹² or R¹¹³ is a cyano group or a hydrocarbon group having 1 to 6 carbon atoms and having a cyano group, and
M represents an alkali metal.

The hydrocarbon group having 1 to 10 carbon atoms represented by R¹¹¹ may be a linear hydrocarbon group, or may be a hydrocarbon group having a branched structure.

The hydrocarbon group having 1 to 10 carbon atoms represented by R¹¹¹ is preferably an alkyl group having 1 to 10 carbon atoms, more preferably an alkyl group having 1 to 6 carbon atoms, still more preferably an alkyl group having 1 to 3 carbon atoms, particularly preferably an alkyl group having 1 or 2 carbon atoms, and most preferably an alkyl group having 1 carbon atom (i.e., a methyl group).

The fluorinated hydrocarbon group having 1 to 10 carbon atoms represented by R¹¹¹ is a group having a structure in which at least one hydrogen atom in the hydrocarbon group having 1 to 10 carbon atoms is substituted with a fluorine atom.

A preferred embodiment of the hydrocarbon group having 1 to 10 carbon atoms, which serves as a base of the fluorinated hydrocarbon group having 1 to 10 carbon atoms represented by R¹¹¹, is the same as the preferred embodiment of the hydrocarbon group having 1 to 10 carbon atoms represented by R¹¹¹ described above.

R¹¹¹ is preferably a fluorinated hydrocarbon group having 1 to 10 carbon atoms, in which a fluoroalkyl group having 1 to 10 carbon atoms is preferable, a fluoroalkyl group having 1 to 6 carbon atoms is further preferable, a fluoroalkyl group having 1 to 3 carbon atoms is more preferable, a fluoroalkyl group having 1 or 2 carbon atoms is still more preferable, an alkyl group having 1 carbon atoms is particularly preferable, and a trifluoromethyl group is most preferable.

Each of R¹¹² and R¹¹³ independently represents a hydrogen atom, a cyano group, a hydrocarbon group having 1 to 6 carbon atoms, a hydrocarbon group having 1 to 6 carbon atoms and having a cyano group, or a halogenated hydrocarbon group having 1 to 6 carbon atoms. Here, at least one of R¹¹² or R¹¹³ is a cyano group or a hydrocarbon group having 1 to 6 carbon atoms and a cyano group.

The hydrocarbon group having 1 to 6 carbon atoms, represented by each of R¹¹² and R¹¹³, may be a linear hydrocarbon group, or may be a hydrocarbon group having a branched structure.

The hydrocarbon group having 1 to 6 carbon atoms, represented by each of R¹¹² and R¹¹³, is preferably an alkyl group having 1 to 6 carbon atoms, more preferably an alkyl group having 1 to 3 carbon atoms, still more preferably an alkyl group having 1 or 2 carbon atoms, and particularly preferably an alkyl group having 1 carbon atom (i.e., a methyl group).

The hydrocarbon group having 1 to 6 carbon atoms and the cyano group, represented by each of R¹¹² and R¹¹³, is a group obtained by substituting at least one hydrogen atom (preferably, a single hydrogen atom) in the hydrocarbon group having 1 to 6 carbon atoms with a cyano group.

A preferred embodiment of the hydrocarbon group having 1 to 6 carbon atoms, which serves as a base of the hydrocarbon group having 1 to 6 carbon atoms and having a cyano group represented by each of R¹¹² and R¹¹³, is the same as the preferred embodiment of the hydrocarbon group having 1 to 6 carbon atoms represented by each of R¹¹² and R¹¹³.

The halogenated hydrocarbon group having 1 to 6 carbon atoms, represented by each of R¹¹² and R¹¹³, is a group obtained by substituting at least one hydrogen atom (preferably, a single hydrogen atom) in the hydrocarbon group having 1 to 6 carbon atoms with a halogen atom.

A preferred embodiment of the hydrocarbon group having 1 to 6 carbon atoms, which serves as a base of the halogenated hydrocarbon group represented by each of R¹¹² and R¹¹³, is the same as the preferred embodiment of the hydrocarbon group having 1 to 6 carbon atoms represented by each of R¹¹² and R¹¹³.

The halogen atom in the halogenated hydrocarbon group represented by each of R¹¹² and R¹¹³ is preferably a fluorine atom, a chlorine atom, a bromine atom, or an iodine atom, more preferably a fluorine atom, a chlorine atom, or a bromine atom, still more preferably a fluorine atom or a chlorine atom, and particularly preferably a fluorine atom.

At least one of R¹¹² or R¹¹³ is a cyano group or a hydrocarbon group having 1 to 6 carbon atoms and having a cyano group.

A preferred embodiment of R¹¹² and R¹¹³ is an embodiment in which each of R¹¹² and R¹¹³ is independently a cyano group, or a hydrocarbon group having 1 to 6 carbon atoms and a cyano group. A further preferred embodiment of R¹¹² and R¹¹³ is an embodiment in which both R¹¹² and R¹¹³ are cyano groups.

M is an alkali metal.

Examples of the alkali metal include lithium, sodium, and potassium. Among these, M is preferably lithium.

As the compound (11), the following compound (11)-1 is particularly preferable.

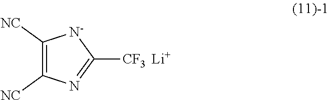 [SMILES: N#Cc1nc(C(F)(F)F)[n-]c1C#N ; [Li+]]

In a case in which the compound (B) includes the compound (11), the content of the compound (11) is preferably from 0.01% by mass to 5.0% by mass, more preferably from 0.05% by mass to 3.0% by mass, still more preferably from 0.10% by mass to 1.5% by mass, and particularly preferably from 0.20% by mass to 1.5% by mass, with respect to the total amount of the nonaqueous electrolytic solution.

The combinations of the compounds (1) to (8) as the compound (A) and the compounds (9) to (11) as the compound (B) are not particularly limited, but preferred combinations are as follows.

It is preferable that the compound (A) is composed of the compound (2) and at least one selected from the group consisting of the compound (3), the compound (4), the compound (5), the compound (6), the compound (7), and the compound (8), and that the compound (B) is composed of the compound (9).

Specifically, the nonaqueous electrolytic solution may include the compound (2), and the compound (3) and the compound (9). The nonaqueous electrolytic solution may include the compound (2), and the compound (4) and the compound (9). The nonaqueous electrolytic solution may include the compound (2), and the compound (5) and the compound (9). The nonaqueous electrolytic solution may include the compound (2), and the compound (6) and the compound (9). The nonaqueous electrolytic solution may include the compound (2), and the compound (7) and the compound (9). The nonaqueous electrolytic solution may include the compound (2), and the compound (8) and the compound (9).

It is preferable that the compound (A) is composed of the compound (1) and at least one selected from the group consisting of the compound (2), the compound (3), the compound (4), the compound (5), the compound (6), the compound (7), and the compound (8), and that the compound (B) is composed of the compound (9).

Specifically, the nonaqueous electrolytic solution may include the compound (1), and the compound (2) and the compound (9). The nonaqueous electrolytic solution may include the compound (1), and the compound (3) and the compound (9). The nonaqueous electrolytic solution may include the compound (1), and the compound (4) and the compound (9). The nonaqueous electrolytic solution may include the compound (1), and the compound (5) and the compound (9). The nonaqueous electrolytic solution may include the compound (1), and the compound (6) and the compound (9). The nonaqueous electrolytic solution may include the compound (1), and the compound (7) and the compound (9).

It is preferable that the compound (A) is composed of the compound (1), and that the compound (B) is composed of the compound (9) and at least one selected from the group consisting of the compound (10) and the compound (11).

Specifically, the nonaqueous electrolytic solution may include the compound (1), the compound (9), and the compound (10). The nonaqueous electrolytic solution may include the compound (1), the compound (9), and the compound (11).

In the nonaqueous electrolytic solution, it is preferable that the compound (A) includes the compound (5).

Specifically, the nonaqueous electrolytic solution may include the compound (5) and the compound (9). The nonaqueous electrolytic solution may include the compound (5) and the compound (10). The nonaqueous electrolytic solution may include the compound (5) and the compound (11).

The compound (A) preferably includes the compound (7).

Specifically, the nonaqueous electrolytic solution may include the compound (7) and the compound (9). The nonaqueous electrolytic solution may include the compound (7) and the compound (10). The nonaqueous electrolytic solution may include the compound (7) and the compound (11).

The compound (A) preferably includes the compound (8).

Specifically, the nonaqueous electrolytic solution may include the compound (8) and the compound (9). The nonaqueous electrolytic solution may include the compound (8) and the compound (10). The nonaqueous electrolytic solution may include the compound (8) and the compound (11).

The nonaqueous electrolytic solution is preferably used in a lithium secondary battery including a positive electrode active material including a lithium metal phosphate.

In a case in which the nonaqueous electrolytic solution is used in a lithium secondary battery including a positive electrode active material including a lithium metal phosphate, it is preferable that the compound (A) is composed of at least one selected from the group consisting of the compound (1), the compound (2), the compound (3), and the compound (4), and that the compound (B) is composed of at least one selected from the group consisting of the compound (9) and the compound (10).

Specifically, the nonaqueous electrolytic solution may include the compound (1) and the compound (9). The nonaqueous electrolytic solution may include the compound (2) and the compound (9). The nonaqueous electrolytic solution may include the compound (3) and the compound (9). The nonaqueous electrolytic solution may include the compound (4) and the compound (9). The nonaqueous electrolytic solution may include the compound (1) and the compound (10). The nonaqueous electrolytic solution may include the compound (2) and the compound (10). The nonaqueous electrolytic solution may include the compound (3) and the compound (10). The nonaqueous electrolytic solution may include the compound (4) and the compound (10).

### <Nonaqueous Solvent>

The nonaqueous electrolytic solution generally includes a nonaqueous solvent.

A nonaqueous solvent can be appropriately selected from various solvents known in the art. The nonaqueous solvent may be used singly or two or more types of nonaqueous solvents may be used.

Examples of the nonaqueous solvent include cyclic carbonates, fluorine-containing cyclic carbonates, chain carbonates, fluorine-containing chain carbonates, aliphatic carboxylic acid esters, fluorine-containing aliphatic carboxylic acid esters, γ-lactones, fluorine-containing γ-lactones, cyclic ethers, fluorine-containing cyclic ethers, chain ethers, fluorine-containing chain ethers, nitriles, amides, lactams, nitromethane, nitroethane, sulfolane, trimethyl phosphate, dimethyl sulfoxide, and dimethyl sulfoxide phosphoric acid.

Examples of the cyclic carbonates include ethylene carbonate (EC), propylene carbonate (PC), and butylene carbonate (BC).

Examples of the fluorine-containing cyclic carbonates include fluoroethylene carbonate (FEC).

Examples of the chain carbonates include dimethyl carbonate (DMC), diethyl carbonate (DEC), ethyl methyl carbonate (EMC), methyl propyl carbonate (MPC), ethyl propyl carbonate (EPC), and dipropyl carbonate (DPC).

Examples of the aliphatic carboxylic acid esters include methyl formate, methyl acetate, methyl propionate, methyl butyrate, methyl isobutyrate, methyl trimethylbutyrate, ethyl formate, ethyl acetate, ethyl propionate, ethyl butyrate, ethyl isobutyrate, and ethyl trimethylbutyrate.

Examples of the γ-lactones include γ-butyrolactone and γ-valerolactone.

Examples of the cyclic ethers include tetrahydrofuran, 2-methyltetrahydrofuran, tetrahydropyran, 1,3-dioxolane, 4-methyl-1,3-dioxolane, 1,3-dioxane, and 1,4-dioxane.

Examples of the chain ethers include 1,2-ethoxyethane (DEE), ethoxymethoxyethane (EME), diethyl ether, 1,2-dimethoxyethane, and 1,2-dibutoxyethane.

Examples of the nitriles include acetonitrile, glutaronitrile, adiponitrile, methoxyacetonitrile, and 3-methoxypropionitrile.

Examples of the amides include N,N-dimethylformamide.

Examples of the lactams include N-methylpyrrolidinone, N-methyloxazolidinone, and N,N′-dimethylimidazolidinone.

The nonaqueous solvent preferably includes at least one selected from the group consisting of cyclic carbonates, fluorine-containing cyclic carbonates, chain carbonates, and fluorine-containing chain carbonates.

In this case, the ratio of the sum of the cyclic carbonates, the fluorine-containing cyclic carbonates, the chain carbonates, and the fluorine-containing chain carbonates is preferably from 50% by mass to 100% by mass, more preferably from 60% by mass to 100% by mass, and still more preferably from 80% by mass to 100% by mass, with respect to the total amount of the nonaqueous solvent.

The nonaqueous solvent preferably includes at least one selected from the group consisting of cyclic carbonates and chain carbonates.

In this case, the total content of the cyclic carbonates and the chain carbonates in the nonaqueous solvent is preferably from 50% by mass to 100% by mass, more preferably from 60% by mass to 100% by mass, and still more preferably from 80% by mass to 100% by mass, with respect to the total amount of the nonaqueous solvent.

The lower limit of the content of the nonaqueous solvent is preferably 60% by mass or more, and more preferably 70% by mass or more, with respect to the total amount of the nonaqueous electrolytic solution.

The upper limit of the content of the nonaqueous solvent is preferably 99% by mass, preferably 97% by mass, and more preferably 90% by mass, with respect to the total amount of the nonaqueous electrolytic solution.

### <Electrolyte>

The nonaqueous electrolytic solution generally includes an electrolyte.

The electrolyte preferably includes at least one of a fluorine-containing lithium salt (hereinafter, it may be referred to as a “fluorine-containing lithium salt”) or a lithium salt containing no fluorine.

Examples of the fluorine-containing lithium salt include inorganic acid anion salts and organic acid anion salts.

Examples of the inorganic acid anion salts include lithium hexafluorophosphate (LiPF₆), lithium tetrafluoroborate (LiBF₄), lithium hexafluoroarsenate (LiAsF₆), and lithium hexafluorotantalate (LiTaF₆).

Examples of the organic acid anion salts include lithium trifluoromethanesulfonate (LiCF₃SO₃), lithium bis(trifluoromethanesulfonyl)imide (Li(CF₃SO₂)₂N), and lithium bis(pentafluoroethanesulfonyl)imide (Li(C₂F₅SO₂)₂N).

Among these, the fluorine-containing lithium salt is more preferably lithium hexafluorophosphate (LiPF₆).

Examples of the lithium salt containing no fluorine include lithium perchlorate (LiClO₄), lithium tetrachloroaluminate (LiAlCl₄), and lithium decachlorodecaborate (Li₂B₁₀Cl₁₀).

In a case in which the electrolyte includes a fluorine-containing lithium salt, the content ratio of the fluorine-containing lithium salt is preferably from 50% by mass to 100% by mass, more preferably from 60% by mass to 100% by mass, and still more preferably from 80% by mass to 100% by mass, with respect to the total amount of the electrolyte.

In a case in which the fluorine-containing lithium salt includes lithium hexafluorophosphate (LiPF₆), the content ratio of lithium hexafluorophosphate (LiPF₆) is preferably from 50% by mass to 100% by mass, more preferably from 60% by mass to 100% by mass, and still more preferably from 80% by mass to 100% by mass, with respect to the total amount of the electrolyte.

In a case in which the nonaqueous electrolytic solution includes an electrolyte, the concentration of the electrolyte in the nonaqueous electrolytic solution is preferably from 0.1 mol/L to 3 mol/L, more preferably from 0.2 mol/L to 2 mol/L, and still more preferably from 0.5 mol/L to 2 mol/L.

In a case in which the nonaqueous electrolytic solution includes lithium hexafluorophosphate (LiPF₆), the concentration of lithium hexafluorophosphate (LiPF₆) in the nonaqueous electrolytic solution is preferably from 0.1 mol/L to 3 mol/L, more preferably from 0.2 mol/L to 2 mol/L, and still more preferably from 0.5 mol/L to 2 mol/L.

### <Other Components>

The nonaqueous electrolytic solution may include other components as necessary.

Examples of other components include acid anhydrides.

### [Lithium Secondary Battery Precursor]

A lithium secondary battery precursor of the present disclosure includes:
a case,
a positive electrode, a negative electrode, a separator, and an electrolytic solution housed in the case.

Here, the positive electrode includes a positive electrode active material including a lithium metal phosphate, and the electrolytic solution is the nonaqueous electrolytic solution of the present disclosure.

In the present disclosure, the lithium secondary battery precursor refers to a lithium secondary battery that has not experienced charging and discharging.

According to the lithium secondary battery precursor of the present disclosure, a lithium secondary battery improved in capacity retention rate after being stored at high-temperature or reduced in resistance in a region where SOC is medium or lower can be produced.

Such an effect is brought by a combination of the compound (A) and the compound (B) in the nonaqueous electrolytic solution.

### <Case>

The shape of the case is not particularly limited, and appropriately selected according to the use of the lithium secondary battery precursor of the present disclosure and the like.

Examples of the case include a case including a laminate film, a case composed of a battery can and a battery-can lid.

### <Positive Electrode>

The positive electrode preferably includes a positive electrode active material.

Examples of the positive electrode active material include:
a transition metal oxide or a transition metal sulfide, such as MoS₂, TiS₂, MnO₂, or V₂O₅;
a composite oxide composed of lithium and a transition metal, such as LiCoO₂, LiMnO₂, LiMn₂O₄, LiNiO₂, LiNi_{X}Co_{(1-X)} O₂ (0<X<1), or LiNiₓCo_{y}Mn_{z}O₂ (in which each of x, y, and z is independently more than 0 and less than 1.00, and the sum of x, y, and z is from 0.99 to 1.00) (i.e., “NCM”, for example, LiNi_{0.33}Co_{0.33}Mn_{0.33}O₂, LiNi_{0.5}Co_{0.3}Mn_{0.2}O₂, LiNi_{0.5}Co_{0.2}Mn_{0.3}O₂, LiNi_{0.6}Co_{0.2}Mn_{0.2}O₂, and LiNi_{0.8}Co_{0.1}Mn_{0.1}O₂);
a composite oxide composed of lithium, a transition metal, and a post-transition metal, such as LiₜNi1−x−yCoₓAl_{y}O₂ (in which t is from 0.95 to 1.15, x is from 0 to 0.3, y is from 0.1 to 0.2, and the sum of x and y is less than 0.5) (i.e., “NCA”, for example, LiNi_{0.8}Co_{0.15}Al_{0.05}O₂);
a conductive polymer material, such as polyaniline, polythiophene, polypyrrole, polyacetylene, polyacene, dimercaptothiadiazole, or polyaniline complex; and
a lithium metal phosphate, such as lithium iron phosphate (LiFePO₄), lithium manganese phosphate (LiMnPO₄), lithium manganese iron phosphate (LiMnₓFe₁₋ₓPO₄, 0<X<1), lithium cobalt phosphate (LiCoPO₄), or lithium nickel phosphate (LiNiPO₄).

The positive electrode active material preferably includes a lithium metal phosphate. The nonaqueous electrolytic solution of the present disclosure can improve the capacity retention rate after storage at a high temperature, or reduce the resistance of the battery in a region where SOC is medium or lower, and is particularly excellent in its effect of improving the capacity retention rate during storage of a battery including the positive electrode active material including a lithium metal phosphate (for example, lithium iron phosphate). It is conceivable that one reason for this is that a metal is eluted from a lithium metal phosphate as a positive electrode active material during storage of the battery and deposited on a negative electrode. In this regard, according to the nonaqueous electrolytic solution of the present disclosure, the capacity retention rate during storage of a battery including a positive electrode active material including a lithium metal phosphate (for example, lithium iron phosphate) can be improved. The reason why such an effect is exhibited is not clear, but is presumably as follows. As a cause of the decrease in the capacity retention rate during storage in the lithium secondary battery, it is considered that a metal is eluted from a positive electrode active material including a lithium metal phosphate during storage of the battery, and deposited on a negative electrode.

Examples of the lithium metal phosphate include lithium iron phosphate (LiFePO₄), lithium manganese phosphate (LiMnPO₄), lithium manganese iron phosphate (LiMnₓFe₁₋ₓPO₄, 0<X<1), lithium cobalt phosphate (LiCoPO₄), and lithium nickel phosphate (LiNiPO₄).

The positive electrode active material preferably includes lithium iron phosphate.

In a case in which the positive electrode active material includes a lithium metal phosphate, the positive electrode active material may include components other than the lithium metal phosphate.

Examples of components other than the lithium metal phosphate include:
a transition metal oxide or a transition metal sulfide, such as MoS₂, TiS₂, MnO₂, or V₂O₅;
a composite oxide composed of lithium and a transition metal, such as LiCoO₂, LiMnO₂, LiMn₂O₄, LiNiO₂, LiNiₓCo_{(1-X)}O₂ [0<X<1], or LiNiₓCo_{y}Mn_{z}O₂ [in which each of x, y, and z is independently more than 0 and less than 1.00, and the sum of x, y, and z is from 0.99 to 1.00](i.e., “NCM”, for example, LiNi_{0.33}Co_{0.33}Mn_{0.33}O₂, LiNi_{0.5}Co_{0.3}Mn_{0.2}O₂, LiNi_{0.5}Co_{0.2}Mn_{0.3}O₂, LiNi_{0.6}Co_{0.2}Mn_{0.2}O₂, and LiNi_{0.8}Co_{0.1}Mn_{0.1}O₂);
a composite oxide composed of lithium, a transition metal, and a post-transition metal, such as LiₜNi_{1-x-y}CoₓAl_{y}O₂ [in which t is from 0.95 to 1.15, x is from 0 to 0.3, y is from 0.01 to 0.2, and the sum of x and y is less than 0.5](i.e., “NCA”, for example, LiNi_{0.8}Co_{0.15}Al_{0.05}O₂); and
a conductive polymer material, such as polyaniline, polythiophene, polypyrrole, polyacetylene, polyacene, dimercaptothiadiazole, or polyaniline complex.

In a case in which the positive electrode active material includes the lithium metal phosphate, the content ratio of the lithium metal phosphate in the positive electrode active material is preferably 70% by mass or more, more preferably 80% by mass or more, and still more preferably 90% by mass or more.

In a case in which the positive electrode active material includes the lithium metal phosphate, the content ratio of the lithium metal phosphate in the positive electrode active material may be 100% by mass or may be less than 100% by mass.

In a case in which the positive electrode active material includes the lithium metal phosphate, the content ratio of lithium iron phosphate in the positive electrode active material is preferably 70% by mass or more, more preferably 80% by mass or more, and still more preferably 90% by mass or more.

In a case in which the positive electrode active material includes the lithium metal phosphate, the content ratio of lithium iron phosphate in the positive electrode active material may be 100% by mass or may be less than 100% by mass.

The positive electrode preferably includes a positive electrode mixture layer including a positive electrode active material.

The positive electrode mixture layer may include components other than the positive electrode active material.

Examples of the components other than the positive electrode active material include a conductive aid and a binder.

Examples of the conductive aids include carbon materials such as carbon black (for example, acetylene black), amorphous whisker, and graphite.

Examples of the binder include polyvinylidene fluoride.

The positive electrode mixture layer can be formed by applying a positive electrode mixture slurry including a positive electrode active material and a solvent onto a positive electrode current collector as described later, and drying the slurry.

The positive electrode mixture slurry may include components (for example, a conductive aid and a binder) other than the positive electrode active material.

Examples of the solvent in the positive electrode mixture slurry include an organic solvent such as N-methylpyrrolidone.

The content ratio of the positive electrode active material in the total solid content of the positive electrode mixture layer is preferably 70% by mass or more, more preferably 80% by mass or more, and still more preferably 90% by mass or more.

The content ratio of the positive electrode active material in the total solid content of the positive electrode mixture layer may be 100% by mass.

Here, the “total solid content of the positive electrode mixture layer” refers to the total amount obtained by removing the amount of the solvent from the positive electrode mixture layer if the solvent remains in the positive electrode mixture layer, and refers to the total amount of the positive electrode mixture layer if the solvent does not remain in the positive electrode mixture layer.

The content ratio of the lithium metal phosphate in the total solid content of the positive electrode mixture layer is preferably 70% by mass or more, more preferably 80% by mass or more, and still more preferably 90% by mass or more.

The content ratio of the lithium metal phosphate in the total solid content of the positive electrode mixture layer may be 100% by mass or may be less than 100% by mass.

The content ratio of the lithium iron phosphate in the total solid content of the positive electrode mixture layer is preferably 70% by mass or more, more preferably 80% by mass or more, and still more preferably 90% by mass or more.

The content ratio of the lithium iron phosphate in the total solid content of the positive electrode mixture layer may be 100% by mass or may be less than 100% by mass.

The positive electrode preferably includes a positive electrode current collector.

The material of the positive electrode current collector is not particularly limited, and any material known in the art can be used.

Examples of the positive electrode current collector include metal materials such as aluminum, an aluminum alloy, stainless steel, nickel, titanium, and tantalum, and carbon materials such as carbon cloth and carbon paper.

### <Negative Electrode>

The negative electrode preferably includes a negative electrode active material.

Examples of the negative electrode active material that can be used include at least one selected from the group consisting of metal lithium, a lithium-containing alloy, a metal or alloy that can be alloyed with lithium, an oxide that can be doped/undoped with a lithium ion, a transition metal nitride that can be doped/undoped with a lithium ion, and a carbon material that can be doped/undoped with a lithium ion.

Examples of the metal or alloy that can be alloyed with lithium (or a lithium ion) include silicon, a silicon alloy, tin, and a tin alloy.

Examples of the negative electrode active material include lithium titanate.

Among these, a carbon material that can be doped/undoped with a lithium ion is preferable.

Examples of such a carbon material include carbon black, activated carbon, a graphite material (e.g., artificial graphite, natural graphite), and an amorphous carbon material. The form of the carbon material may be any one of a fibrous form, a spherical form, a potato-like form, or a flake form.

Examples of the amorphous carbon material include hard carbon, coke, mesocarbon microbeads (MCMB) calcined at 1500° C. or less, and mesophase pitch carbon fiber (MCF).

Examples of the graphite material include natural graphite and artificial graphite. Examples of the artificial graphite that can be used include graphitized MCMB and graphitized MCF. Examples of the graphite material that can be used include materials containing boron. Examples of the graphite material that can be used include materials coated with a metal (such as gold, platinum, silver, copper, or tin), materials coated with amorphous carbon, and mixtures of amorphous carbon and graphite.

These carbon materials may be used singly, or two or more kinds thereof may be used in combination. Specifically, as the carbon material, a carbon material having a plane-spacing d(002) of 0.340 nm or less as measured by X-ray analysis is preferable. As the carbon material, graphite having a true density of 1.70 g/cm³ or more, or a highly crystalline carbon material having properties close to such graphite is also preferable. In a case in which the above carbon material is used, the energy density of the battery can be further increased.

The content ratio of the carbon material (preferably the graphite material) in the negative electrode active material is preferably 70% by mass or more, more preferably 80% by mass or more, and still more preferably 90% by mass or more.

The content ratio of the carbon material (preferably the graphite material) in the negative electrode active material may be 100% by mass or may be less than 100% by mass.

The negative electrode preferably includes a negative electrode mixture layer including a negative electrode active material.

The negative electrode mixture layer may include components other than the negative electrode active material.

Examples of the components other than the negative electrode active material include a conductive additive and a binder.

Examples of the conductive additive include the same conductive additives as those exemplified as the conductive additive that can be included in the positive electrode mixture layer.

Examples of the binder include carboxymethyl cellulose and SBR latex.

The negative electrode mixture layer can be formed by applying a negative electrode mixture slurry including a negative electrode active material and a solvent onto a negative electrode current collector as described later, and drying the slurry.

The negative electrode mixture slurry may include components (for example, a conductive additive and a binder) other than the negative electrode active material.

Examples of the solvent in the negative electrode mixture slurry include water.

The content ratio of the negative electrode active material in the total solid content of the negative electrode mixture layer is preferably 70% by mass or more, more preferably 80% by mass or more, and still more preferably 90% by mass or more.

The content ratio of the negative electrode active material in the total solid content of the negative electrode mixture layer may be 100% by mass.

Here, the “total solid content of the negative electrode mixture layer” refers to the total amount obtained by removing the amount of the solvent from the negative electrode mixture layer if the solvent remains in the negative electrode mixture layer, and refers to the total amount of the negative electrode mixture layer if a solvent does not remain in the negative electrode mixture layer.

The content ratio of the carbon material (preferably the graphite material) in the total solid content of the negative electrode mixture layer is preferably 70% by mass or more, more preferably 80% by mass or more, and still more preferably 90% by mass or more.

The content ratio of the carbon material (preferably the graphite material) in the total solid content of the negative electrode mixture layer may be 100% by mass.

The negative electrode preferably includes a negative electrode current collector.

The material of the negative electrode current collector is not particularly limited, and any material known in the art can be used.

Examples of the negative electrode current collector include metal materials such as copper, nickel, stainless steel, and nickel-plated steel. Among these, copper is particularly preferable because it is easily processed.

### <Separator>

Examples of the separator include a porous resin flat plate. Examples of the material for the porous resin flat plate include a resin and a nonwoven fabric including the resin. Examples of the resin include polyethylene (PE), polypropylene (PP), polymethylpentene (PMP), polyester, cellulose, and polyamide.

Among these, the separator is preferably a single-layer or multilayer porous resin sheet. The material of the porous resin sheet is mainly composed of one or more polyolefin resins. The thickness of the separator is preferably from 5 μm to 30 μm. The separator is preferably disposed between the positive electrode and the negative electrode.

### <Specific Example of Lithium Secondary Battery Precursor>

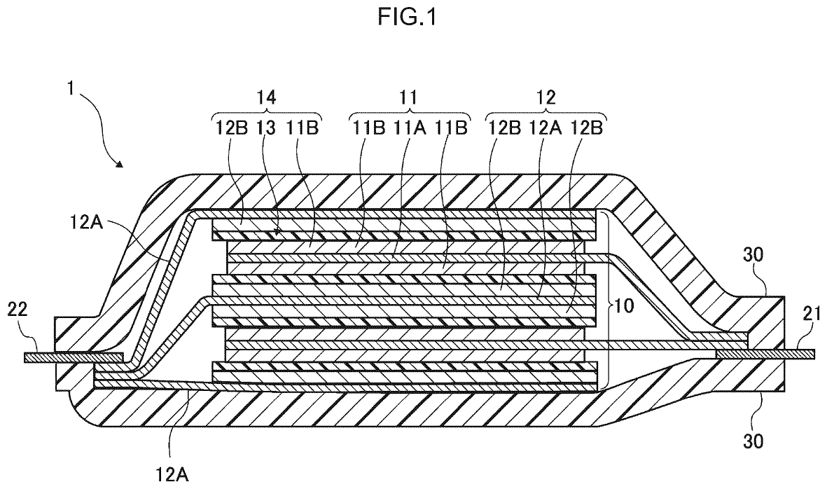

FIG. 1 is a schematic cross-sectional view illustrating a laminate-type lithium secondary battery precursor, which is one example of the lithium secondary battery precursor of the present disclosure.

As shown in FIG. 1, a lithium secondary battery precursor 1 is a laminate-type battery precursor.

Specifically, in the lithium secondary battery precursor 1, a battery element 10 is housed in an outer package 30. The outer package 30 is formed of a laminate film. To the battery element 10, each of a positive electrode lead 21 and a negative electrode lead 22 is attached. The positive electrode lead 21 and the negative electrode lead 22 are guided out in the opposite directions from the inside to the outside of the outer package 30.

As illustrated in FIG. 1, the battery element 10 is formed by layering a positive electrode 11, a separator 13, and a negative electrode 12. The positive electrode 11 has a positive electrode mixture layer 11B formed on both main surfaces of a positive electrode current collector 11A. The negative electrode 12 has a negative electrode mixture layer 12B formed on both main surfaces of a negative electrode current collector 12A. The positive electrode mixture layer 11B, formed on one of the main surfaces of the positive electrode current collector 11A of the positive electrode 11, and the negative electrode mixture layer 12B, formed on one of the main surfaces of the negative electrode current collector 12A of the negative electrode 12 adjacent to the positive electrode 11, face each other with the separator 13 interposed therebetween.

The nonaqueous electrolytic solution of the present disclosure is injected into the outer package 30 of the lithium secondary battery precursor 1. The nonaqueous electrolytic solution of the present disclosure penetrates into the positive electrode mixture layer 11B, the separator 13, and the negative electrode mixture layer 12B. In the lithium secondary battery precursor 1, a single battery layer 14 is formed of the positive electrode mixture layer 11B, the separator 13, and the negative electrode mixture layer 12B which are arranged adjacent to each other. The positive electrode and the negative electrode may be ones in which a mixture layer is formed on one of the surfaces of respective current collectors.

The lithium secondary battery precursor 1 is a precursor of a laminate-type lithium secondary battery. However, the lithium secondary battery precursor of the present disclosure is not limited thereto, and may be, for example, a precursor of wound-type lithium secondary battery. The wound-type lithium secondary battery precursor is obtained by layering a positive electrode, a separator, a negative electrode, and a separator in this order and winding them into a layered structure. Examples of the wound-type lithium secondary battery precursors include cylindrical lithium secondary battery precursors and prismatic lithium secondary battery precursors.

As illustrated in FIG. 1, in the lithium secondary battery precursor 1, each of the positive electrode lead and the negative electrode lead protrudes outward from the interior of the outer package 30 in directions opposite to each other with respect to the outer package 30, but the present disclosure is not limited thereto. For example, each of the positive electrode lead and the negative electrode lead may protrude outward from the interior of the outer package 30 in the same direction with respect to the outer package 30.

One example of the lithium secondary battery of the present disclosure described later includes a lithium secondary battery obtained by subjecting the lithium secondary battery precursor 1 to charging and discharging.

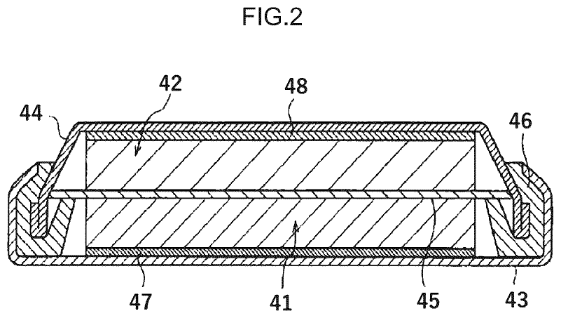

FIG. 2 is a schematic cross-sectional view illustrating a coin-type lithium secondary battery precursor, which is another example of the lithium secondary battery precursor according to the present disclosure.

In the coin-type lithium secondary battery precursor shown in FIG. 2, a disk-shaped negative electrode 42, a separator 45 into which a nonaqueous electrolytic solution has been injected, a disk-shaped positive electrode 41, and if required, spacer plates 47 and 48 made of, for example, stainless steel or aluminum, are housed between a positive electrode can 43 (hereinafter, also referred to as a “battery can”) and a sealing plate 44 (hereinafter, also referred to as a “battery-can lid”) while being layered in this order. The positive electrode can 43 and the sealing plate 44 are airtightly sealed by crimping with a gasket 46 interposed therebetween.

In this example, the nonaqueous electrolytic solution of the present disclosure is used as the nonaqueous electrolytic solution injected into the separator 45.

Examples of the lithium secondary battery of the present disclosure described later include a lithium secondary battery obtained by subjecting the coin-type lithium secondary battery precursor illustrated in FIG. 2 to charging and discharging.

### [Lithium Secondary Battery and Method for Producing the Battery]

A method for producing a lithium secondary battery according to the present disclosure includes:
a step of preparing the lithium secondary battery precursor of the present disclosure described above (hereinafter, referred to as the “preparation step”); and
a step of subjecting the lithium secondary battery precursor to charging and discharging.

The lithium secondary battery of the present disclosure is a lithium secondary battery obtained by subjecting the lithium secondary battery precursor of the present disclosure described above to charging and discharging.

According to the lithium secondary battery and the method for producing the battery, the capacity retention rate of the lithium secondary battery during storage can be improved.

The preparation step may be a step of simply preparing the lithium secondary battery precursor of the present disclosure that has been produced in advance for subjecting it to the charge and discharge step, or may be a step of producing the lithium secondary battery precursor of the present disclosure.

The lithium secondary battery precursor is as described above.

In the step of performing charge and discharge, the lithium secondary battery precursor can be charged and discharged in accordance with a known method.

In this step, the charge-discharge cycle may be repeated a plurality of times for the lithium secondary battery precursor.

As described above, by this charge and discharge, a solid electrolyte interface (SEI) film is preferably formed on the surface of the positive electrode (particularly the positive electrode active material) and/or the negative electrode (particularly the negative electrode active material) in the lithium secondary battery precursor.

In the step of performing charge and discharge, a combination of charging or discharging of the lithium secondary battery precursor is preferably performed one or more times in an environment of from 25° C. to 70° C.

### EXAMPLES

Examples according to the present disclosure are described below. However, the present disclosure is not limited to the Examples described below.

### Example 1-1

### <Preparation of Nonaqueous Electrolytic Solution>

Ethylene carbonate (hereinafter, referred to as “EC”), dimethyl carbonate (hereinafter, referred to as “DMC”), and ethyl methyl carbonate (hereinafter, referred to as “EMC”) were mixed. The volume ratio (EC:DMC:EMC) was 30:35:35. In this manner, a mixed solvent was obtained as a nonaqueous solvent.

In the resulting mixed solvent, LiPF₆ was dissolved as an electrolyte so that the concentration thereof in the final nonaqueous electrolytic solution would be 1.2 mol/liter, thereby obtaining an electrolytic solution (hereinafter, also referred to as the “basic electrolytic solution”).

To the obtained basic electrolytic solution, the compounds listed in Table 1 were added so that the contents thereof with respect to the total amount of the final nonaqueous electrolytic solution would correspond to the contents (% by mass) listed in Table 1, thereby obtaining a nonaqueous electrolytic solution. In Table 1, compound (2)-1 (i.e., lithium difluorophosphate) is an example of the compound (2), compound (3)-1 is an example of the compound (3), and compound (9)-1 is an example of the compound (9).

### <Production of Positive Electrode>

A mixture was obtained by mixing LiNi_{0.5}Co_{0.2}Mn_{0.3}O₂ (90% by mass) as a positive electrode active material, carbon black (2.5% by mass) and graphite (2.5% by mass) as a conductive additive, and polyvinylidene fluoride (PVdF) (5% by mass) as a binder. The obtained mixture was dispersed in N-methylpyrrolidone as a solvent to obtain a positive electrode mixture slurry.

An aluminum foil having a thickness of 20 μm was prepared as a positive electrode current collector.

The obtained positive electrode mixture slurry was applied onto an aluminum foil, dried, and then rolled with a press machine to obtain a sheet-like positive electrode. The positive electrode is composed of a positive electrode current collector and a positive electrode mixture layer.

### <Production of Negative Electrode>

A negative electrode mixture slurry was obtained by mixing graphite (96% by mass) as a negative electrode active material, carbon black (1% by mass) as a conductive additive, sodium carboxymethylcellulose as a thickener dispersed in pure water in an amount of 1% by mass in terms of solid content, and styrene-butadiene rubber (SBR) as a binder dispersed in pure water in an amount of 2% by mass in terms of solid content.

A copper foil having a thickness of 10 μm was prepared as a negative electrode current collector.

The obtained negative electrode mixture slurry was applied onto the copper foil, dried, and then rolled with a press machine to obtain a sheet-like negative electrode. The negative electrode is composed of a negative electrode current collector and a negative electrode mixture layer.

### <Preparation of Separator>

A porous polyethylene film was prepared as a separator.

### <Preparation of Lithium Secondary Battery Precursor>

The negative electrode was punched into a disk-shaped piece having a diameter of 14 mm. The positive electrode was punched into a disk-shaped piece having a diameter of 13 mm. The separator was punched into a disk-shaped piece having a diameter of 17 mm. In this way, a coin-shaped negative electrode, a coin-shaped positive electrode, and a coin-shaped separator were obtained.

The obtained coin-shaped negative electrode, coin-shaped separator, and coin-shaped positive electrode were layered in this order inside a stainless steel battery can (size 2032). Subsequently, 20 μL of the nonaqueous electrolytic solution was injected into the battery can, thereby impregnating the separator, the positive electrode, and the negative electrode with the nonaqueous electrolytic solution.

Subsequently, an aluminum plate (thickness 1.2 mm, diameter 16 mm) and a spring were placed on the positive electrode, and the battery can lid was sealed by crimping with a polypropylene gasket to airtightly seal the battery.

In this manner, a coin-type lithium secondary battery precursor (i.e., the lithium secondary battery that has not experienced charging and discharging) having the structure shown in FIG. 2 was obtained. The size of the lithium secondary battery precursor was 20 mm in diameter and 3.2 mm in height.

### <Production of Lithium Secondary Battery>

The lithium secondary battery precursor obtained above was repeatedly charged to 4.2 V and discharged to 2.5 V within a temperature range of 25° C. to 70° C. This operation was repeated three times, thereby obtaining a lithium secondary battery.

The lithium secondary battery obtained above was subjected to the following measurements. The results are shown in Table 1. Individual results were shown as relative values with the values of Reference Example 1-1 (described later) taken as 100.

### <Battery Resistance (SOC50%)>

The lithium secondary battery obtained above was charged until the SOC (state of charge) became 50%.

DCIR (direct-current internal resistance) [Ω] of the charged lithium secondary battery was measured.

The obtained result was defined as battery resistance (SOC50%).

The above operations were performed in a thermostatic chamber of 25° C.

### <Battery Resistance (SOC25%)>

After battery resistance (SOC50%) was measured, the lithium secondary battery was discharged until the SOC became 25%.

DCIR (direct current internal resistance) [Ω] of the discharged lithium secondary battery was measured.

The obtained result was defined as battery resistance (SOC25%).

The above operations were performed in a thermostatic chamber of 25° C.

### Examples 1-2 and 1-3, and Reference Example 1-1

Nonaqueous electrolytic solutions were obtained in the same manner as Example 1-1, except that the types and contents of additives in the nonaqueous electrolytic solutions were changed as shown in Table 1. Using the obtained nonaqueous electrolytic solutions, the battery resistance (SOC50%) and the battery resistance (SOC25%) were measured in the same manner as Example 1-1. The results are shown in Table 1. The additives added to each of the nonaqueous electrolytic solutions of Examples 1-2 and 1-3 and Reference Example 1-1 are as shown in the following formulae. The compound (6)-1 (i.e., bis(fluorosulfonyl)imide) of Reference Example 1-1 is a specific example of the compound (6). Individual results are shown as relative values with the value of Reference Example 1-1 taken as 100.

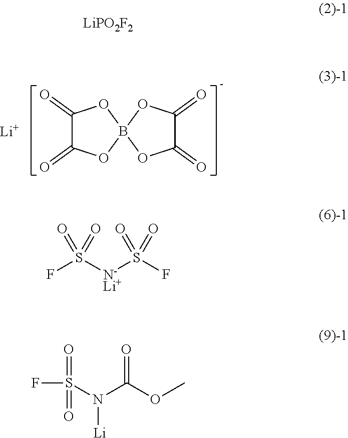

TABLE 1

| | Type and content of additives in nonaqueous | | | | | |
|---|---|---|---|---|---|---|
| | electrolytic solution | | | | Battery resistance | |
| | Compound (A) | | | Compound (B) | SOC50% | SOC25% |
| | (2)-1 | (3)-1 | (6)-1 | (9)-1 | Relative | Relative |
| | % by mass | % by mass | % by mass | % by mass | value | value |
| Reference | 1.0 | 0.5 | 0.5 | 0 | 100 | 100 |
| Example 1-1 | | | | | | |
| Example 1-1 | 1.0 | 0.5 | 0 | 0.2 | 83 | 85 |
| Example 1-2 | 1.0 | 0.5 | 0 | 0.5 | 81 | 77 |
| Example 1-3 | 1.0 | 0.5 | 0 | 1.0 | 79 | 74 |

As shown in Table 1, the nonaqueous electrolytic solution for a battery in each of Examples 1-1 to 1-3 included the compound (A) and the compound (B). The compound (A) in each of Examples 1-1 to 1-3 was composed of the compound (2) and the compound (3). The compound (B) in each of Examples 1-1 to 1-3 was composed of the compound (9). The nonaqueous electrolytic solution for a battery in Reference Example 1-1 included the compound (A) but did not include the compound (B). Therefore, the battery resistance value in each of Examples 1-1 to 1-3 was lower as compared to that of Reference Example 1-1 in the region where SOC is medium or lower (specifically, SOC of 50% and SOC of 25%).

### Examples 2-1 to 2-17 and Comparative Example 2-1

### <Preparation of Nonaqueous Electrolytic Solution>

Nonaqueous electrolytic solutions were obtained in the same manner as Example 1-1, except that the types and contents of additives in the nonaqueous electrolytic solution were changed as shown in Table 2.

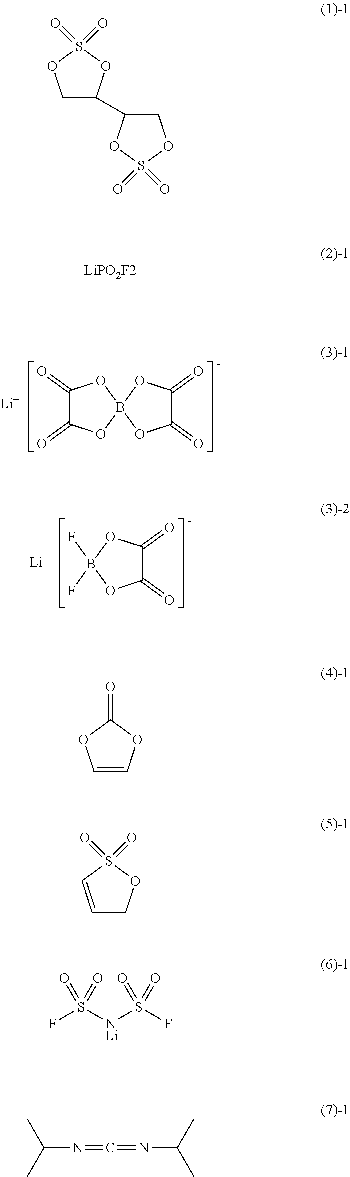

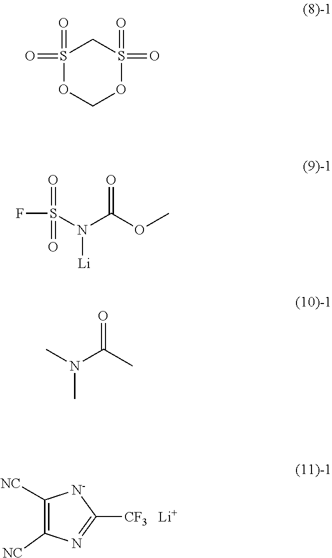

### <Production of Lithium Secondary Battery>

Using the obtained nonaqueous electrolytic solution, lithium secondary batteries were obtained in the same manner as Example 1-1.

The lithium secondary battery obtained above was subjected to the following measurements. The results are shown in Table 2. Individual results were shown as relative values with the values of Comparative Example 2-1 taken as 100. The symbol “-” in Table 2 means that the no additives were added. “Unmeasured” in Table 2 means that the measurement was not performed.

### <Measurement of Initial Discharge Capacity>

The lithium secondary battery was subjected to constant-current constant-voltage (CC-CV) charging at a charge rate of 0.2 C up to 3.5 V in a thermostatic chamber of 25° C., and subsequently, the initial (i.e., before high-temperature storage) discharge capacity (0.2 C) (mAh) was measured at a discharge rate of 0.2 C at 25° C.

### <Storage at High Temperature>

Subsequently, the lithium secondary battery for which initial discharge capacity (0.2 C) had been measured was CC-CV charged to 4.2 V at a charge rate of 0.2 C at 25° C., and thereafter stored in a temperature environment of 60° C. (hereinafter, referred to as “high-temperature storage”). The storage time at the high temperature will be described later.

<Measurement of Recovered Discharge Capacity after High-Temperature Storage>

Seven days after the start of high-temperature storage (i.e., after 7 days of storage), the recovered discharge capacity after high-temperature storage was measured as follows.

The lithium secondary battery after high-temperature storage was subjected to CC discharge at a discharge rate of 0.2 C at 25° C. until the SOC reached 0%, and then subjected to CC-CV charge up to 4.2 V at a charge rate of 0.2 C. Subsequently, the lithium secondary battery was subjected to CC discharge at a discharge rate of 0.2 C, and the recovered discharge capacity (0.2 C) (mAh) after high-temperature storage was measured.

### <Capacity Retention Rate During Storage>

Seven days after the start of high-temperature storage, the capacity retention rate during storage was calculated by the following expression. In Table 2, the initial (i.e., before high-temperature storage) capacity retention rate (i.e., the capacity retention rate: 100%) is also shown.

$$Capacity retention rate during storage ( \% ) = [ ( Recovered discharge capacity after high - temperature storage ( 0.2 C ) ) / ( Initial discharge capacity ( 0.2 C ) ) ] \times 100$$

### <Battery Resistance (25° C.)>

The lithium secondary batteries obtained above were charged until the SOC became 50%.

DCIR (direct-current internal resistance) [Ω] of the charged lithium secondary battery was measured.

The obtained result was defined as battery resistance (SOC50%).

The above operations were performed in a thermostatic chamber of 25° C.

### <Battery Resistance (−10° C.)>

The lithium secondary batteries obtained above were charged until the SOC became 50%.

DCIR (direct-current internal resistance) [Ω] of the charged lithium secondary battery was measured.

The obtained result was defined as battery resistance (SOC50%).

The above operations were performed in a thermostatic chamber of −10° C.

TABLE 2

| | | | | | | | | | | | | | | Evaluation results | | | |
|---|---|---|---|---|---|---|---|---|---|---|---|---|---|---|---|---|---|
| | | | | | | | | | | | | | | Capacity retention | | Battery | Battery |
| | Type and content of additives in nonaqueous electrolytic solution | | | | | | | | | | | | | rate | | resistance | resistance |
| | Compound (A) | | | | | | | | | | Compound (B) | | | | After | (25° C.) | (−10° C.) |
| | (1)-1 | (2)-1 | (3)-1 | (3)-2 | (4)-1 | (5)-1 | (5)-2 | (6)-1 | (7)-1 | (8)-1 | (9)-1 | (10)-1 | (11)-1 | Initial | 7 | SOC50% | SOC50% |
| | % by | % by | % by | % by | % by | % by | % by | % by | % by | % by | % by | % by | % by | time | days | Relative | Relative |
| | mass | mass | mass | mass | mass | mass | mass | mass | mass | mass | mass | mass | mass | % | % | value | value |
| Comparative | — | — | — | — | — | — | — | — | — | — | 0.5 | — | — | 100 | 89 | 100 | 100 |
| Example 2-1 | | | | | | | | | | | | | | | | | |
| Example 2-1 | — | 0.5 | — | — | — | — | — | — | — | — | 0.5 | — | — | 100 | 89 | 91 | 85 |
| Example 2-2 | — | 0.5 | 0.5 | — | — | — | — | — | — | — | 0.5 | — | — | 100 | 90 | 95 | 88 |
| Example 2-3 | — | 0.5 | — | 0.5 | — | — | — | — | — | — | 0.5 | — | — | 100 | 89 | 90 | 83 |
| Example 2-4 | — | 0.5 | — | — | — | — | — | 0.5 | — | — | 0.5 | — | — | 100 | 89 | 90 | 84 |
| Example 2-5 | — | 0.5 | — | — | 0.5 | — | — | — | — | — | 0.5 | — | — | 100 | 89 | 100 | 90 |
| Example 2-6 | — | 0.5 | — | — | — | — | — | — | 0.1 | — | 0.5 | — | — | 100 | 89 | 100 | 85 |
| Example 2-7 | 0.5 | 0.5 | — | — | — | — | — | — | — | — | 0.5 | — | — | 100 | 90 | 99 | 91 |
| Example 2-8 | — | 0.5 | — | — | — | — | — | — | — | 0.5 | 0.5 | — | — | 100 | 89 | 86 | 78 |
| Example 2-9 | — | 0.5 | — | — | — | 0.5 | 0.5 | — | — | — | 0.5 | — | — | 100 | 90 | 99 | 92 |
| Example 2-10 | 0.5 | — | — | — | — | — | — | — | — | — | 0.5 | — | — | 100 | 91 | 96 | 96 |
| Example 2-11 | 0.5 | — | — | 0.5 | — | — | — | — | — | — | 0.5 | — | — | 100 | 89 | 95 | 91 |
| Example 2-12 | 0.5 | — | — | — | — | — | — | 0.5 | — | — | 0.5 | — | — | 100 | 90 | Not | Not |
| | | | | | | | | | | | | | | | | measured | measured |
| Example 2-13 | 0.5 | — | — | — | 0.5 | — | — | — | — | — | 0.5 | — | — | 100 | 90 | 96 | 101 |
| Example 2-14 | 0.5 | — | — | — | — | — | — | — | 01 | — | 0.5 | — | — | 100 | 90 | 100 | 94 |
| Example 2-15 | 0.5 | — | — | — | — | — | — | — | — | 0.5 | 0.5 | — | — | 100 | 91 | 93 | 91 |
| Example 2-16 | 0.5 | — | — | — | — | 0.5 | — | — | — | — | 0.5 | — | — | 100 | 90 | Not | Not |
| | | | | | | | | | | | | | | | | measured | measured |
| Example 2-17 | 0.5 | — | — | — | — | — | 0.5 | — | — | — | 0.5 | — | — | 100 | 90 | Not | Not |
| | | | | | | | | | | | | | | | | measured | measured |

As shown in Table 2, the nonaqueous electrolytic solution in each of Examples 2-1 to 2-17 included the compound (A) and the compound (B). The compound (A) in each of Examples 2-1 to 2-17 was at least one compound selected from the group consisting of the compound (1), the compound (2), the compound (3), the compound (4), the compound (5), the compound (6), the compound (7), and the compound (8). The compound (B) in each of Examples 2-1 to 2-17 was composed of the compound (9). The nonaqueous electrolytic solution of Comparative Example 2-1 included the compound (B) but did not include the compound (A). The compound (B) in Comparative Example 2-1 was composed of the compound (9). The capacity retention rate in each of Examples 2-1 to 2-17 was improved as compared with Comparative Example 2-1, or the battery resistance value in each of Examples 2-1 to 2-17 was reduced as compared with Comparative Example 2-1 in the region where SOC is medium or lower (specifically, SOC of 50% (25° C.) and SOC of 50% (−10° C.)).

### Example 3-1

### <Preparation of Nonaqueous Electrolytic Solution>

As a nonaqueous solvent, ethylene carbonate (EC), dimethyl carbonate (DMC), and methylethyl carbonate (EMC) were mixed, thereby obtaining a mixed solvent. The volume ratio (EC:DMC:EMC) was 20:35:45.

LiPF₆ as an electrolyte was dissolved in the resulting mixed solvent so that the concentration thereof in the final nonaqueous electrolytic solution would be 0.9 mol/liter.

Additives were added to the obtained solution as follows, thereby obtaining a nonaqueous electrolytic solution.

The above-mentioned compound (9)-1, as a specific example of the compound (9), was added so that the content thereof became 1.0% by mass, with respect to the total mass of the nonaqueous electrolytic solution.

Further, the above-mentioned compound (1)-1, as a specific example of the compound (1), was added so that the content thereof became 0.5% by mass, with respect to the total mass of the nonaqueous electrolytic solution.

### <Production of Positive Electrode>

Lithium iron phosphate (LiFePO₄, hereinafter, also referred to as “LFP”) (90 parts by mass) as a positive electrode active material, acetylene black (5 parts by mass) as a conductive additive, and polyvinylidene fluoride (5 parts by mass) as a binder were kneaded with N-methylpyrrolidinone as a solvent, thereby preparing a paste-like positive electrode mixture slurry.

Subsequently, the positive electrode mixture slurry was applied onto a positive electrode current collector made of a strip-shaped aluminum foil having a thickness of 20 μm, dried, and then compressed with a roll press, thereby obtaining a sheet-shaped positive electrode composed of a positive electrode current collector and a positive electrode mixture layer. At this time, the coating density of the positive electrode mixture layer was 12 mg/cm², and the packing density was 2.0 g/mL.

### <Production of Negative Electrode>

Natural graphite (98 parts by mass) as a negative electrode active material, carboxymethyl cellulose (1 part by mass) as a binder, and SBR latex (1 part by mass) as a binder were kneaded with water as a solvent, thereby preparing a paste-like negative electrode mixture slurry.

Subsequently, the negative electrode mixture slurry was applied onto a negative electrode current collector made of a strip-shaped copper foil having a thickness of 10 μm, dried, and then compressed with a roll press, thereby obtaining a sheet-like negative electrode composed of a negative electrode current collector and a negative electrode mixture layer. At this time, the coating density of the negative electrode mixture layer was 6.0 mg/cm², and the packing density was 1.5 g/mL.

### <Preparation of Separator>

As a separator, a microporous polyethylene film having a thickness of 20 μm was prepared.

### <Preparation of Lithium Secondary Battery Precursor>

The above-described negative electrode was punched into a disk-shaped piece having a diameter of 14 mm. The above-described positive electrode was punched into a disk-shaped piece having a diameter of 13 mm. In this way, a coin-shaped negative electrode and a coin-shaped positive electrode were obtained. The separator was punched into a disk-shaped piece having a diameter of 17 mm, thereby obtaining a coin-shaped separator.

The obtained coin-shaped negative electrode, coin-shaped separator, and coin-shaped positive electrode were layered in this order inside a stainless-steel battery can (size 2032). Subsequently, 18 μL of the nonaqueous electrolytic solution was injected into the battery can, thereby impregnating the separator, the positive electrode, and the negative electrode with the solution.

Subsequently, an aluminum plate (thickness 1.2 mm, diameter 16 mm) and a spring were placed on the positive electrode, and the battery can lid was sealed by crimping with a polypropylene gasket to airtightly seal the battery.

In this manner, a coin-type lithium secondary battery precursor (i.e., the lithium secondary battery that has not experienced charging and discharging) having the structure shown in FIG. 2 was obtained. The size of the lithium secondary battery precursor was 20 mm in diameter and 3.2 mm in height.

### <Preparation of Lithium Secondary Battery (Charge and Discharge of Lithium Secondary Battery Precursor)>

The lithium secondary battery precursor obtained above was repeatedly charged to 3.5 V and discharged to 2.0 V at a temperature of 25° C. This operation was repeated three times, thereby obtaining a lithium secondary battery.

### <Measurement of Initial Discharge Capacity>

The lithium secondary battery obtained above was subjected to constant-current constant-voltage (CC-CV) charging at a charge rate of 0.2 C up to 3.5 V in a thermostatic chamber at 25° C., and subsequently, the initial (i.e., before high-temperature storage) discharge capacity (0.2 C) (mAh) was measured at a discharge rate of 0.2 C at 25° C.

### <Storage at High Temperature>

Subsequently, the lithium secondary battery for which initial discharge capacity (0.2 C) had been measured was charged by CC-CV to 3.5 V at a charge rate of 0.2 C at 25° C., and thereafter stored in a temperature environment of 60° C. (hereinafter, referred to as “high-temperature storage”). The storage time at the high temperature will be described later.

### <Measurement of Recovered Discharge Capacity After High-Temperature Storage>

Seven days after the start of high-temperature storage (i.e., after 7 days of storage) and 14 days after the start of high-temperature storage, the recovered discharge capacity after high-temperature storage was measured as follows.

The lithium secondary battery after high-temperature storage was subjected to CC discharge at a discharge rate of 0.2 C at 25° C. until the state of charge (SOC) reached 0%, and then charged by CC-CV to 3.5 V at a charge rate of 0.2 C. Subsequently, the lithium secondary battery was subjected to CC discharge at a discharge rate of 0.2 C, and the recovered discharge capacity (0.2 C) (mAh) after high-temperature storage was measured.

### <Capacity Retention Rate During Storage>

For each of the time points 7 days after the start of high-temperature storage and 14 days after the start of high-temperature storage, the capacity retention rate during storage was calculated by the following expression.

The results are shown in Table 3.

In Table 3, the initial (i.e., before high-temperature storage) capacity retention rate (i.e., the capacity retention rate is 100%) is also shown.

$$Capacity retention rate during storage ( \% ) = [ ( Recovered discharge capacity after high - temperature storage ( 0.2 C ) ) / Initial discharge capacity ( 0.2 C ) ) ] \times 100$$

### Examples 3-2 to 3-14 and Comparative Examples 3-1 to 3-3

Nonaqueous electrolytic solutions were obtained in the same manner as Example 3-1, except that the types and contents of the additives used for preparation of the nonaqueous electrolytic solutions were changed as shown in Table 3. Using each of the obtained nonaqueous electrolytic solutions, the initial capacity retention rate, the capacity retention rate during storage 7 days after the start of high-temperature storage, and the capacity retention rate during storage 14 days after that start of high-temperature storage were measured in the same manner as Example 3-1.

The results are shown in Table 3. The additives added to each of the nonaqueous electrolytic solutions in Examples 3-1 to 3-14 and Comparative Examples 3-1 to 3-3 are as shown in the following formulae. The symbol “-” in Table 3 means that no additives were added.

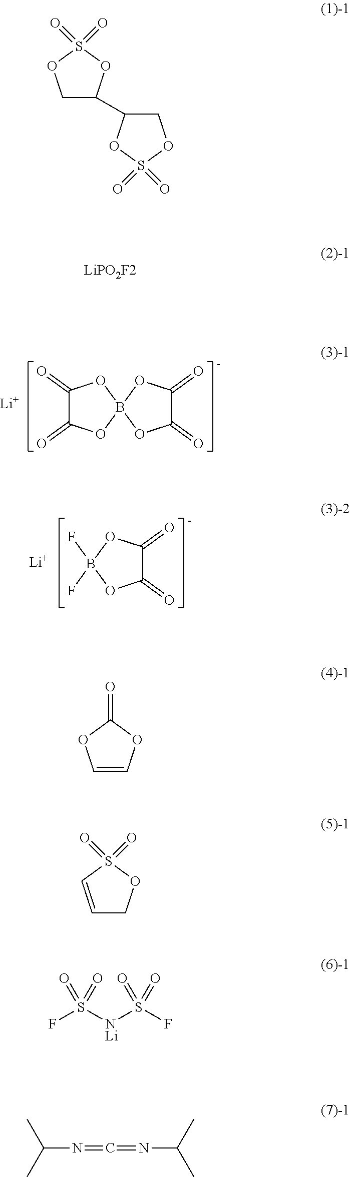

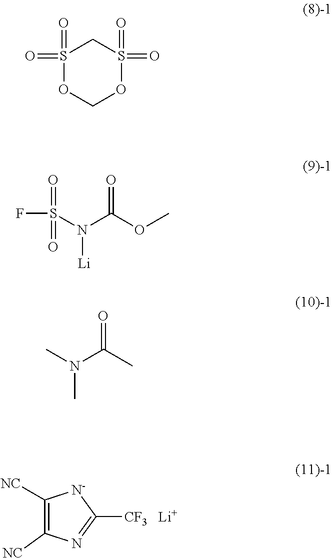

TABLE 3

| | Type and content of additives in nonaqueous electrolytic solution | | | | | | | |
|---|---|---|---|---|---|---|---|---|
| | Compound (A) | | | | | | | |
| | (1)-1 | (2)-1 | (3)- | (3)-2 | (4)-1 | (5)-1 | (6)-1 | (7)-1 |
| | % by | % by | % by | % by | % by | % by | % by | % by |
| | mass | mass | mass | mass | mass | mass | mass | mass |
| Example 3-1 | 0.50 | — | — | — | — | — | — | — |
| Example 3-2 | 0.75 | — | — | — | — | — | — | — |
| Example 3-3 | 1.00 | — | — | — | — | — | — | — |
| Example 3-4 | — | 0.25 | — | — | — | — | — | — |
| Example 3-5 | — | — | 025 | — | — | — | — | — |
| Example 3-6 | — | — | — | — | 0.25 | — | — | — |
| Example 3-7 | — | — | — | — | — | 0.25 | — | — |
| Example 3-8 | 1.00 | 0.25 | — | — | — | — | — | — |
| Example 3-9 | 1.00 | — | 025 | — | — | — | — | — |
| Example 3-10 | 1.00 | — | — | 0.25 | — | — | — | — |
| Example 3-11 | 1.00 | — | — | — | 0.25 | — | — | — |
| Example 3-12 | 1.00 | — | — | — | — | 0.25 | — | — |
| Example 3-13 | 0.50 | — | — | — | — | 0.25 | — | — |
| Example 3-14 | 0.50 | — | — | — | — | 0.25 | — | — |
| Comparative | — | — | — | — | — | — | — | — |
| Example 3-1 | | | | | | | | |
| Comparative | — | — | — | — | — | — | — | — |
| Example 3-2 | | | | | | | | |
| Comparative | — | — | — | — | — | — | — | — |
| Example 3-3 | | | | | | | | |

| | Compound | | | | Evaluation results | | |
|---|---|---|---|---|---|---|---|
| | (A) | Compound (B) | | | Capacity retention rate | | |
| | (8)-1 | (9)-1 | (10)-1 | (11)-1 | | After | After |
| | % by | % by | % by | % by | Initial | 7 days | 14 days |
| | mass | mass | mass | mass | time % | % | % |
| Example 3-1 | — | 1.00 | — | — | 100 | 87.9 | 80.2 |
| Example 3-2 | — | 1.00 | — | — | 100 | 89.9 | 80.6 |
| Example 3-3 | — | 1.00 | — | — | 100 | 90.3 | 80.7 |
| Example 3-4 | — | 1.00 | — | — | 100 | 87.7 | 79.1 |
| Example 3-5 | — | 1.00 | — | — | 100 | 88.7 | 80.7 |
| Example 3-6 | — | 1.00 | — | — | 100 | 83.1 | 70.8 |
| Example 3-7 | — | 1.00 | — | — | 100 | 84.6 | 74.3 |
| Example 3-8 | — | 1.00 | — | — | 100 | 91.2 | 85.8 |
| Example 3-9 | — | 1.00 | — | — | 100 | 93.0 | 86.5 |
| Example 3-10 | — | 1.00 | — | — | 100 | 91.9 | 85.2 |
| Example 3-11 | — | 1.00 | — | — | 100 | 92.8 | 87.1 |
| Example 3-12 | — | 1.00 | — | — | 100 | 92.4 | 86.9 |
| Example 3-13 | — | — | 1.00 | — | 100 | 87.9 | 80.0 |
| Example 3-14 | — | — | — | 1.00 | 100 | 88.2 | 80.5 |
| Comparative | — | 0.50 | — | — | 100 | 74.7 | 63.0 |
| Example 3-1 | | | | | | | |
| Comparative | — | 1.00 | — | — | 100 | 75.3 | 62.1 |
| Example 3-2 | | | | | | | |
| Comparative | — | 1.50 | — | — | 100 | 77.1 | 64.5 |
| Example 3-3 | | | | | | | |

As shown in Table 3, the nonaqueous electrolytic solution in each of Examples 3-2 to 3-14 included the compound (A) and the compound (B). The nonaqueous electrolytic solution in each of Comparative Examples 3-1 to 3-3 included the compound (B) but did not include the compound (A). Therefore, the capacity retention rate during storage of the battery in each of Examples 3-1 to 3-14 was superior to that of each of Comparative Examples 3-1 to 3-3.

The compound (A) in each of Examples 3-8 to 3-12 was composed of the compound (1) and at least one compound selected from the group consisting of the compound (2), the compound (3), the compound (4), and the compound (5). The compound (A) in each of Examples 3-1 to 3-7 consisted of a single compound. Therefore, the capacity retention rate during storage of the battery in each of Examples 3-8 to 3-12 was even more superior to that of each of Examples 3-1 to 3-7.

### Examples 3-15 to 3-19 and Comparative Example 3-4

The same operation as that in Example 3-1 was carried out, except that the types and contents of the additives used for preparation of nonaqueous electrolytic solutions were changed as shown in Table 4, and that lithium ion secondary battery precursors were prepared as described below. The results are shown in Table 4. The additives added to each of the nonaqueous electrolytic solutions in Examples 3-1 to 3-19 and Comparative Example 3-4 are as shown in the following formulae. The symbol “-” in Table 4 means that no additives were added.

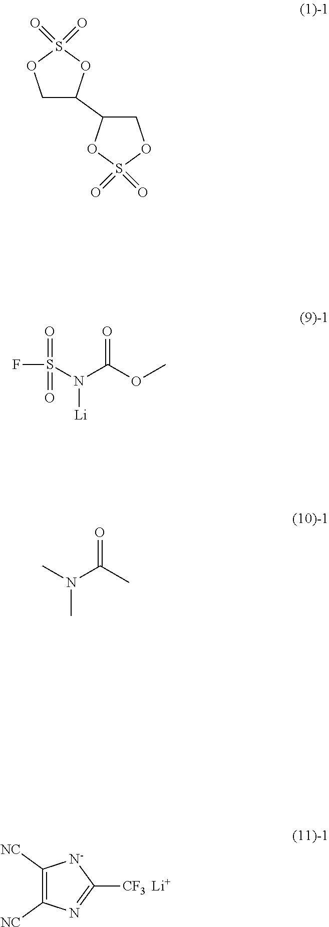

### <Preparation of Lithium Secondary Battery Precursor>

A sheet-shaped negative electrode similar to the sheet-shaped negative electrode of Example 3-1 was prepared, and a sheet-shaped positive electrode similar to the sheet-shaped positive electrode of Example 3-1 was prepared.

The above sheet-shaped negative electrode was punched into a rectangular piece having a length of 42 mm and a width of 31 mm. The above sheet-shaped positive electrode was punched into rectangular pieces having a length of 40 mm and a width of 29 mm. Thus, a rectangular negative electrode and a rectangular positive electrode were obtained separately. The separator was punched into a rectangular piece having a length of 45 mm and a width of 35 mm, thereby obtaining a rectangular separator.

The obtained rectangular negative electrode, rectangular separator, and rectangular positive electrode were layered in this order inside a bag-like aluminum laminate film. Subsequently, 125 μL of the nonaqueous electrolytic solution was injected into the aluminum laminate film, thereby impregnating the rectangular separator, the rectangular positive electrode, and the rectangular negative electrode with the solution.

Subsequently, the opening of the bag was sealed with a heat sealer to airtightly seal the battery.

In this manner, a laminate-type lithium secondary battery precursor (i.e., the lithium secondary battery that has not experienced charging and discharging) having the structure shown in FIG. 1 was obtained.

TABLE 4

| | Type and content of additives in nonaqueous | | | | | | |
|---|---|---|---|---|---|---|---|
| | electrolytic solution | | | | Evaluation results | | |
| | Compound | Compound | | | Capacity retention rate | | |
| | (A) | (B) | | | | After | After |
| | (1)-1 | (9)-1 | (10)-1 | (11)-1 | Initial | 7 | 14 |
| | % by | % by | % by | % by | time | days | days |
| | mass | mass | mass | mass | % | % | % |
| Example 3-15 | 1.00 | 1.00 | — | — | 100 | 88.6 | 87.4 |
| Example 3-16 | 1.00 | 1.00 | 0.25 | — | 100 | 91.4 | 91.0 |
| Example 3-17 | 1.00 | 1.00 | 1.00 | — | 100 | 91.2 | 89.2 |
| Example 3-18 | 1.00 | 1.00 | — | 0.25 | 100 | 93.4 | 90.8 |
| Example 3-19 | 1.00 | 1.00 | — | 1.00 | 100 | 91.3 | 89.7 |
| Comparative | — | 1.00 | — | — | 100 | 82.3 | 75.8 |
| Example 3-4 | | | | | | | |

As shown in Table 4, the nonaqueous electrolytic solution in each of Examples 3-15 to 3-19 included the compound (A) and the compound (B). The nonaqueous electrolytic solution of Comparative Example 3-4 included the compound (B) but did not include the compound (A). Therefore, the capacity retention rate during storage of the battery in each of Examples 3-15 to 3-19 was superior to that of Comparative Example 3-4.

The compound (B) of Examples 3-16 to 3-19 was composed of the compound (9) and at least one compound selected from the group consisting of the compound (10), and the compound (11). The compound (B) of Example 3-15 consisted of a single compound. Therefore, the capacity retention rate during storage of the battery in each of Examples 3-16 to 3-19 was even more superior to that of Example 3-15.

The disclosures of Japanese Patent Application No. 2023-018744, filed on Feb. 9, 2023, Japanese Patent Application No. 2023-040531, filed on Mar. 15, 2023, and Japanese Patent Application No. 2023-104562, filed on Jun. 26, 2023, are incorporated herein by reference in their entirety.

All publications, patent applications, and technical standards mentioned in this specification are herein incorporated by reference to the same extent as if each individual publication, patent application, or technical standard was specifically and individually indicated to be incorporated by reference.

1. A nonaqueous electrolytic solution for a battery, the solution comprising:
a compound (A); and
a compound (B), wherein:
the compound (A) is at least one selected from the group consisting of:
a compound (1) represented by the following Formula (1),
a compound (2) that is at least one selected from the group consisting of lithium monofluorophosphate and lithium difluorophosphate,
a compound (3) represented by the following Formula (3),
a compound (4) represented by the following Formula (4),
a compound (5) represented by the following Formula (5),
a compound (6) represented by the following Formula (6),
a compound (7) represented by the following Formula (7), and
a compound (8) represented by the following Formula (8), and
the compound (B) is at least one selected from the group consisting of:
a compound (9) represented by the following Formula (9),
a compound (10) represented by the following Formula (10), and
a compound (11) represented by the following Formula (11), 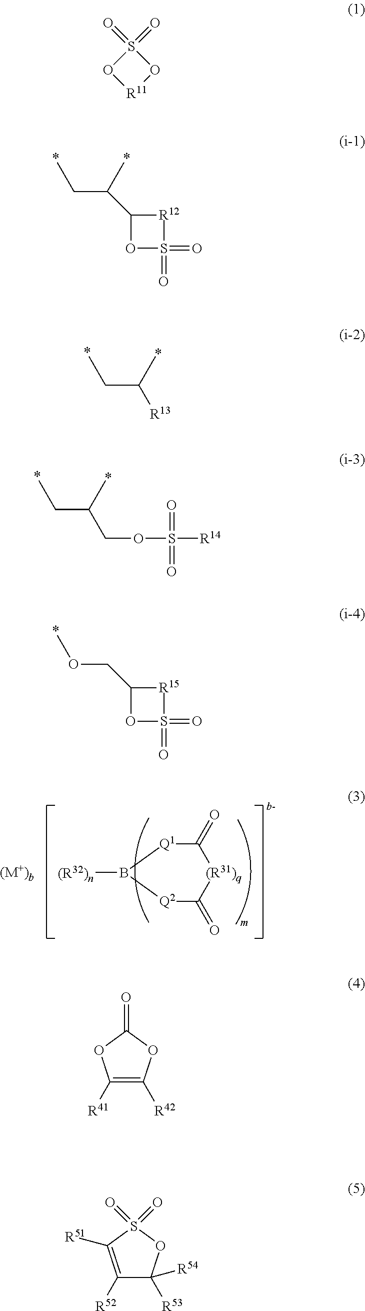 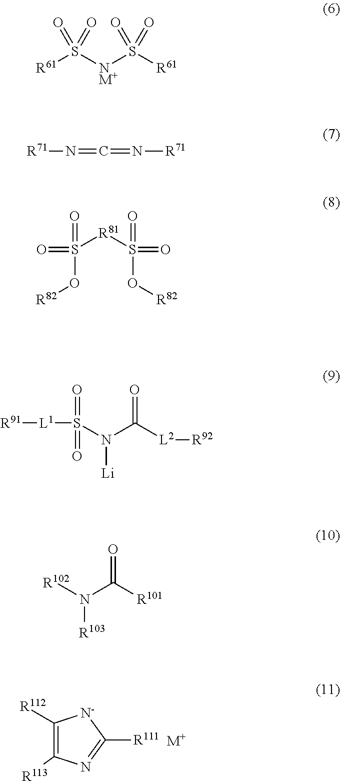
wherein, in Formula (1),
R¹¹ represents an alkylene group having 1 to 6 carbon atoms, an alkenylene group having 2 to 6 carbon atoms, a group represented by Formula (i-1), a group represented by Formula (i-2), or a group represented by Formula (i-3),
in Formula (i-1), R¹² represents an oxygen atom, an alkylene group having 1 to 6 carbon atoms, an alkenylene group having 2 to 6 carbon atoms, or an oxymethylene group, and * represents a binding position,
in Formula (i-2), R¹³ represents an alkyl group having 1 to 6 carbon atoms, an alkenyl group having 2 to 6 carbon atoms, or a hydrogen atom, and * represents a binding position,
in Formula (i-3), R¹⁴ represents a halogen atom, an alkyl group having 1 to 6 carbon atoms, a halogenated alkyl group having 1 to 6 carbon atoms, an alkoxy group having 1 to 6 carbon atoms, or a group represented by Formula (i-4), and * represents a binding position,
in Formula (i-4), R¹⁵ represents an oxygen atom, an alkylene group having 1 to 6 carbon atoms, an alkenylene group having 2 to 6 carbon atoms, or an oxymethylene group, and * represents a binding position;
in Formula (3), M represents an alkali metal, b represents an integer from 1 to 3, m represents an integer from 1 to 4, n represents an integer from 0 to 8, and q represents 0 or 1,
R³¹ represents an alkylene group having 1 to 10 carbon atoms, a halogenated alkylene group having 1 to 10 carbon atoms, an arylene group having 6 to 20 carbon atoms, or a halogenated arylene group having 6 to 20 carbon atoms, these groups may include a substituent or a heteroatom in their structure, and when q is 1 and m is 2 to 4, m instances of R³¹ may be bound together,
R³² represents a halogen atom, an alkyl group having 1 to 10 carbon atoms, a halogenated alkyl group having 1 to 10 carbon atoms, an aryl group having 6 to 20 carbon atoms, or a halogenated aryl group having 6 to 20 carbon atoms, these groups may include a substituent or a heteroatom in their structure, and when n is 2 to 8, n instances of R³² may be linked together to form a ring,
each of Q¹ and Q² independently represents —O— or —CH₂—;
in Formula (4), each of R⁴¹ and R⁴² independently represents a hydrogen atom, a fluorine atom, a hydrocarbon group having 1 to 3 carbon atoms, or a fluorinated hydrocarbon group having 1 to 3 carbon atoms,
in Formula (5), each of R⁵¹ to R⁵⁴ independently represents a hydrogen atom, a fluorine atom, a hydrocarbon group having 1 to 3 carbon atoms, or a fluorinated hydrocarbon group having 1 to 3 carbon atoms, and a double line composed of the solid line and the dotted line represents a single bond or a double bond,
in Formula (6), each R⁶¹ independently represents a fluorine atom or a fluorinated hydrocarbon group having 1 to 6 carbon atoms, and
M represents an alkali metal,
in Formula (7), each R⁷¹ independently represents a hydrocarbon group having 1 to 10 carbon atoms or a trialkylsilyl group having 3 to 18 carbon atoms,
in Formula (8), each R⁸¹ represents an alkylene group having 1 to 10 carbon atoms or a halogenated alkylene group having 1 to 10 carbon atoms, and
each R⁸² independently represents a hydrocarbon group having 1 to 10 carbon atoms or a halogenated hydrocarbon group having 1 to 10 carbon atoms, and, optionally, two R⁸²s may be linked together to form a divalent hydrocarbon group having 1 to 10 carbon atoms or a divalent halogenated hydrocarbon group having 1 to 10 carbon atoms,
in Formula (9),
each of R⁹¹ and R⁹² independently represents an alkyl group having 1 to 10 carbon atoms in which at least one hydrogen atom of the alkyl group may be substituted with a halogen atom, an alkenyl group having 2 to 10 carbon atoms in which at least one hydrogen atom of the alkenyl group may be substituted with a halogen atom, an alkynyl group having 2 to 10 carbon atoms in which at least one hydrogen atom of the alkynyl group may be substituted with a halogen atom, an aryl group in which at least one hydrogen atom of the aryl group may be substituted with a halogen atom, an alkoxy group having 1 to 6 carbon atoms, or an alkyl group having 1 to 6 carbon atoms, or a halogen atom, and
each of L¹ and L² independently represents a single bond or —O—,
in Formula (10), each of R¹⁰¹ to R¹⁰³ independently represents a hydrogen atom or a hydrocarbon group having 1 to 10 carbon atoms, and
in Formula (11),
R¹¹¹ represents a hydrogen atom, a hydrocarbon group having 1 to 10 carbon atoms, or a fluorinated hydrocarbon group having 1 to 10 carbon atoms,
each of R¹¹² and R¹¹³ independently represents a hydrogen atom, a cyano group, a hydrocarbon group having 1 to 6 carbon atoms, a hydrocarbon group having 1 to 6 carbon atoms and having a cyano group, or a halogenated hydrocarbon group having 1 to 6 carbon atoms, provided that at least one of R¹¹² or R¹¹³ is a cyano group or a hydrocarbon group having 1 to 6 carbon atoms and having a cyano group, and
M represents an alkali metal.

2. The nonaqueous electrolytic solution for a battery according to claim 1, wherein:
the compound (A) is composed of compound (2) and at least one selected from the group consisting of the compound (3), the compound (4), the compound (5), the compound (6), the compound (7), and the compound (8), and
the compound (B) is composed of the compound (9).

3. The nonaqueous electrolytic solution for a battery according to claim 1, wherein:
the compound (A) is composed of the compound (1) and at least one selected from the group consisting of the compound (2), the compound (3), the compound (4), the compound (5), the compound (6), the compound (7), and the compound (8), and
the compound (B) is composed of the compound (9).

4. The nonaqueous electrolytic solution for a battery according to claim 1, wherein:
the compound (A) is composed of the compound (1), and
the compound (B) is composed of the compound (9) and at least one selected from the group consisting of the compound (10) and the compound (11).

5. The nonaqueous electrolytic solution for a battery according to claim 1, wherein the compound (A) comprises the compound (5).

6. The nonaqueous electrolytic solution for a battery according to claim 1, wherein the compound (A) comprises the compound (7).

7. The nonaqueous electrolytic solution for a battery according to claim 1, wherein the compound (A) comprises the compound (8).

8. The nonaqueous electrolytic solution for a battery according to claim 1, which is used in a lithium secondary battery comprising a positive electrode active material comprising a lithium metal phosphate.

9. The nonaqueous electrolytic solution for a battery according to claim 8, wherein:
the compound (A) is composed of at least one selected from the group consisting of the compound (1), the compound (2), the compound (3), and the compound (4), and
the compound (B) is composed of at least one selected from the group consisting of the compound (9) and the compound (10).

10. A lithium secondary battery precursor, comprising
a case, and
a positive electrode, a negative electrode, a separator, and an electrolytic solution housed in the case, wherein:
the positive electrode comprises a positive electrode active material comprising a lithium metal phosphate, and
the electrolytic solution is the nonaqueous electrolytic solution for a battery according to claim 1.

11. A lithium secondary battery obtained by subjecting the lithium secondary battery precursor according to claim 10 to charging and discharging.

12. A method for producing a lithium secondary battery, the method comprising:
preparing the lithium secondary battery precursor according to claim 10; and
subjecting the lithium secondary battery precursor to charging and discharging.
